(19) United States
(12) Patent Application Publication
(10) Pub. No.: US 2025/0367969 A1
(43) Pub. Date: Dec. 4, 2025

(54) LOAD MOVEMENT EFFECTOR AND METHOD OF USE

(71) Applicant: Kundel Industries, Inc., Vienna, OH (US)

(72) Inventor: Robert KUNDEL, SR., Cortland, OH (US)

(73) Assignee: Kundel Industries, Inc., Vienna, OH (US)

(21) Appl. No.: 18/934,639

(22) Filed: Nov. 1, 2024

Related U.S. Application Data
(60) Provisional application No. 63/654,391, filed on May 31, 2024.

(51) Int. Cl. B60B 29/00; B25J 15/06

(52) U.S. Cl. CPC B60B 29/001; B25J 15/0608; B25J 15/0616; B60B 2340/14; B60B 2340/32; B60B 2340/34; B60B 2900/521

(57) ABSTRACT

A load balancer includes an articulating assembly connected with a support mechanism. The articulating assembly is connected to a support assembly where the support assembly is able to secure a load thereto. The articulating assembly articulates the support assembly and thereby the load between a first position and a second position. The articulating assembly includes at least one linkage assembly interposed between the attachment member and the support assembly. The at least one linkage assembly includes an arm and an actuator where the actuator is selectively pivotable relative to the arm. The load balance and the load together have a center of gravity. The center of gravity remains substantially aligned with an attachment to the support mechanism during the articulation of the support assembly between the first position and the second position.

### TECHNICAL FIELD

This disclosure is generally directed to heavy lifting equipment. More particularly, the disclosure relates to heavy lifting equipment utilized, particularly in a factory setting, to install components on machinery. Specifically, the disclosure is directed to an articulated vertical load balancer used to lift components such as large, heavy tires into a correct orientation for installation on machinery such as earth moving equipment.

### BACKGROUND ART

Heavy machinery equipment, such as earth moving equipment, requires tires that must be installed onto the equipment after manufacture or when the tires on the machinery become worn or damaged and need to be replaced. Tires for earth moving equipment can be extremely large and heavy. For example, tires for some mining trucks can be as large as 12.75 ft in diameter, 4.6 ft wide, and weigh around 10,000 lb. Moving these tires so they can be installed onto the earth moving equipment is exceptionally difficult and requires the use of heavy lifting machinery such as a crane. However, using a crane does not make the installation process very easy because a tire suspended from a crane tends to become oriented at an angle relative to vertical and this makes it difficult to correctly orient and position the tire for installation onto the vehicle's axel.

### SUMMARY OF THE INVENTION

A load balancer includes an articulating assembly connected with a support mechanism. The articulating assembly is connected to a support assembly where the support assembly is able to secure a load thereto. The articulating assembly articulates the support assembly and thereby the load between a first position and a second position. The articulating assembly includes at least one linkage assembly interposed between the attachment member and the support assembly. The at least one linkage assembly includes an arm and an actuator where the actuator is selectively pivotable relative to the arm. The load balance and the load together have a center of gravity. The center of gravity remains substantially aligned with the support mechanism during the articulation of the support assembly between the first position and the second position.

In one aspect, an exemplary embodiment of the present disclosure may provide a vertical load balancer comprising an articulating assembly adapted to be engaged with a support mechanism, a support assembly operatively engaged with the articulating assembly, wherein the support assembly is adapted to engage and secure a load thereto and wherein the articulating assembly is operable to articulate the support assembly, and thereby the load, between a first position and a second position.

In one aspect, an exemplary embodiment of the present disclosure may provide a method of articulating a load comprises operatively engaging a load balancer with a support mechanism via an attachment member, securing a load to a support assembly of the load balancer, aligning a center of gravity of the load balancer and the load, together, with a vertical axis passing through the attachment member, articulating, with an articulating assembly, the support assembly and thereby the load from a first position to a second position, and maintaining the center of gravity in alignment with the vertical axis as the support assembly articulates.

In one aspect, an exemplary embodiment of the present disclosure may provide a vertical load balancer for articulating a load, said vertical load balancer comprising an attachment mechanism adapted to engage a support mechanism, a first linkage assembly operably engaged with the attachment mechanism, a second linkage assembly operably engaged with the first linkage assembly, a support assembly adapted to secure a load thereto, wherein the second linkage assembly is operably engageable with the support assembly, and wherein one or both of the first linkage assembly and the second linkage assembly articulates the support assembly from a first position to a second position.

In one aspect, an exemplary embodiment of the present disclosure may provide a single load manipulator comprising an articulating assembly adapted to be engaged with a support mechanism, a support assembly operatively engaged with the articulating assembly, wherein the support assembly is adapted to engage and secure a load thereto, wherein the articulating assembly is operable to articulate the support assembly, and thereby the load, between a first position and a second position, and wherein the first position and the second position are arranged at an angle to one another.

In one aspect, an exemplary embodiment of the present disclosure may provide a single load balancer for articulating a load, said single load balancer comprising an attachment mechanism adapted to engage a support mechanism, a linkage assembly nonremovably engaged with the attachment mechanism, a support assembly engaged with the linkage assembly, wherein the support assembly is adapted to secure a load thereto, and wherein the single load balancer articulates the support assembly and thereby the load from a first position to a second position.

In one aspect, an exemplary embodiment of the present disclosure may provide a method of moving a load comprising operatively engaging a load balancer with a support mechanism via an attachment link, securing the load to a support assembly of the load balancer, articulating the support assembly and the load, with a linkage assembly of the load balancer from a first position to a second position, and maintaining the support assembly and thereby the load substantially parallel to a vertical axis extending through the attachment link while the support assembly is in the second position.

In one aspect, an exemplary embodiment of the present disclosure may provide a load movement effector comprising an articulating assembly operatively engaged with a support mechanism, a support assembly adapted to engage and secure a load thereto, and wherein the articulating assembly moves the support assembly and thereby changes the position of the load.

In another aspect, an exemplary embodiment of the present disclosure may provide wherein the articulating assembly rotates the support assembly and thereby the load about at least one axis. In another aspect, an exemplary embodiment of the present disclosure may provide wherein the at least one axis comprises a first axis which extends through a center point of the support assembly. In another aspect, an exemplary embodiment of the present disclosure may provide wherein the at least one axis further comprises a second axis which orthogonal to the first axis. In another aspect, an exemplary embodiment of the present disclosure may provide further comprising an attachment mechanism operatively engaged with the articulating assembly, wherein the attachment mechanism engages the articulating assembly to the support mechanism. In another aspect, an exemplary embodiment of the present disclosure may provide wherein the articulating assembly comprises a first arm fixedly engaged with the attachment mechanism, a second arm engaged with the first arm, a receiver provided at each of a first end and a second end of the second arm, a connector assembly operatively engaged with each receiver, and wherein each connector assembly engages the support assembly. In another aspect, an exemplary embodiment of the present disclosure may provide wherein the connector assembly comprises a first plate and a second plate opposed and spaced apart from one another, one or more rollers rotatably extending between the first plate and the second plate, and a rod pivotally engaged with first plate and the second plate, and wherein the rod engages an associated receiver of the articulating assembly. In another aspect, an exemplary embodiment of the present disclosure may provide wherein the support assembly comprises a ring which rotatably engages the articulating assembly. In another aspect, an exemplary embodiment of the present disclosure may provide wherein the support assembly further comprises at least one securement member adapted to engage the load. In another aspect, an exemplary embodiment of the present disclosure may provide wherein the at least one securement member is provided on the ring. In another aspect, an exemplary embodiment of the present disclosure may provide further comprising at least one handle provided on the articulating assembly.

In one aspect, an exemplary embodiment of the present disclosure may provide a method of effecting a load comprising providing a support mechanism, engaging an attachment mechanism with the support mechanism, nonremovably engaging an articulating assembly with the attachment mechanism, engaging a support assembly with the articulating assembly, and securing the load to the support assembly.

In another aspect, an exemplary embodiment of the present disclosure may provide further comprising providing a pair of connector assemblies on the articulating assembly, rotating the support assembly about a first axis with the pair of connector assemblies, and wherein the first axis extends through a center point of the support assembly. In another aspect, an exemplary embodiment of the present disclosure may provide further comprising rotating the support assembly with the articulating assembly about a second axis orthogonal to the first axis. In another aspect, an exemplary embodiment of the present disclosure may provide further comprising moving the attachment mechanism, the articulating assembly, the support assembly, and thereby the load via at least one handle located on the articulating assembly. In another aspect, an exemplary embodiment of the present disclosure may further comprise providing at least one securement member on the support assembly and securing the load to the support assembly via at the at least one securement member. In another aspect, an exemplary embodiment of the present disclosure may provide further comprising providing at least one vacuum cup on the support assembly, connecting the at least one vacuum cup to a remote vacuum source, creating a vacuum between the at least one vacuum cup and the load, and securing the load to the support assembly via the vacuum. In another aspect, an exemplary embodiment of the present disclosure may provide further comprising providing at least one magnet assembly on the support assembly, generating a magnetic field with the at least one magnet assembly, and attracting the load to the support assembly via the magnetic field. In another aspect, an exemplary embodiment of the present disclosure may provide further comprising providing at least one clamp assembly on the support assembly and clamping the load to the support assembly with the at least one clamp assembly. In another aspect, an exemplary embodiment of the present disclosure may provide further comprising providing a support plate extending outwardly from the support assembly, providing at least one clamping jaw opposed to the support plate, receiving the load between the support plate and the at least one clamping jaw, and clamping the load between the support plate and the at least one clamping jaw.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a left side elevation view of a first embodiment of a load balancer in accordance with the present disclosure shown in use aligning a load with an axel of a piece of heavy machinery.

FIG. 2 is a front, top, left side perspective view of the first embodiment of the load balancer of FIG. 1 shown in isolation.

FIG. 3A is a left side elevation view of the load balancer shown positioned above a load and being lowered relative thereto to engage the load.

FIG. 3B is a left side elevation view of the load balancer engaged with the load and shown in a first position.

FIG. 3C is a left side elevation view of the load balancer, where the load balancer and load are articulated into a second position.

FIG. 4 is a front, top left side, perspective view of a second embodiment of a load balancer in accordance with an aspect of the present disclosure.

FIG. 5 is a left side elevation view of the load balancer shown in FIG. 4.

FIG. 6 is a rear elevation view of an attachment mechanism of the second embodiment load balancer viewed in the direction of line 6-6 of FIG. 5.

FIG. 7 is a left side elevation view of the load balancer of FIG. 4 shown in operation in a first position.

FIG. 8 is a left side elevation view of the load balancer of FIG. 4 shown in operation and in a second position.

FIG. 9 is a front, top, left side perspective view of a third embodiment of a load balancer in accordance with an aspect of the present disclosure.

FIG. 10 is a partially exploded front, top, left side perspective view of the load balancer shown in FIG. 9.

FIG. 11A is a left side elevation view of the load balancer of FIG. 9 in operation, showing the load balancer with a load secured thereto and the load balancer in a first position.

FIG. 11B is a left side elevation view of the load balancer of FIG. 9 in operation, showing the load balancer moved to a second position.

FIG. 12 is a front, top, left side perspective view of a second embodiment of a support assembly for use in a load balancer in accordance with an aspect of the present disclosure.

FIG. 13 is a rear, top, right side perspective view of the support assembly shown in FIG. 12.

FIG. 14 is a top plan view of the support assembly shown in FIG. 12.

FIG. 15 is a rear elevational view of the support assembly shown in FIG. 12.

FIG. 16 is a cross section of the support assembly taken along line 16-16 in FIG. 15, showing the support assembly prior to engaging a load.

FIG. 17 is a cross section of the support assembly similar to FIG. 16 showing the support assembly after engaging the load.

FIG. 18 is a rear, top, left side perspective view of the support assembly showing a lower region of a pair of linkage assemblies engaging the same, and wherein the support assembly is shown without a load engaged therewith.

FIG. 19 is a front, top, left side perspective view of a third embodiment of a support assembly for use in a load balancer in accordance with an aspect of the present disclosure.

FIG. 20 is a rear, top right side perspective view of the support assembly shown in FIG. 19.

FIG. 21 is a side elevation view of the support assembly shown in FIG. 19.

FIG. 22 is a front elevation view of the support assembly shown in FIG. 19.

FIG. 23 is a cross section of the support assembly taken along line 23-23 of FIG. 22.

FIG. 24 is a front, top, right side perspective view of a fourth embodiment of a load balancer in accordance with the present disclosure.

FIG. 25 is a front, top left side perspective view of a fourth embodiment of a support assembly in accordance with an aspect of the present disclosure which is provided on the load balancer of FIG. 24.

FIG. 26 is a rear, top right side perspective view of the support assembly shown in FIG. 25.

FIG. 27 is a top plan view of the support assembly shown in FIG. 25.

FIG. 28 is a front, top, left side perspective view of a fifth embodiment of a support assembly for use in a load balancer in accordance with an aspect of the present disclosure.

FIG. 29 is a rear, top, right side perspective view of the support assembly shown in FIG. 28.

FIG. 30 is a front elevation view of the support assembly shown in FIG. 28.

FIG. 31 is a front elevation view of the support assembly of FIG. 28 shown engaging a load.

FIG. 32 is an operational view of a portion of an articulating assembly of a load balancer orientating the support assembly of FIG. 28 in a first position.

FIG. 33 is a rear, top, right side perspective view of a portion of the load balancer orientating the support assembly of FIG. 28 in a second position.

FIG. 34 is a front, top, left side perspective view of a fifth embodiment of a load balancer in accordance with an aspect of the present disclosure shown with a sixth embodiment of a support assembly engaged therewith.

FIG. 35 is a rear, top, right side perspective view of the load balancer shown in FIG. 34.

Similar numbers refer to similar parts throughout the drawings.

### DETAILED DESCRIPTION

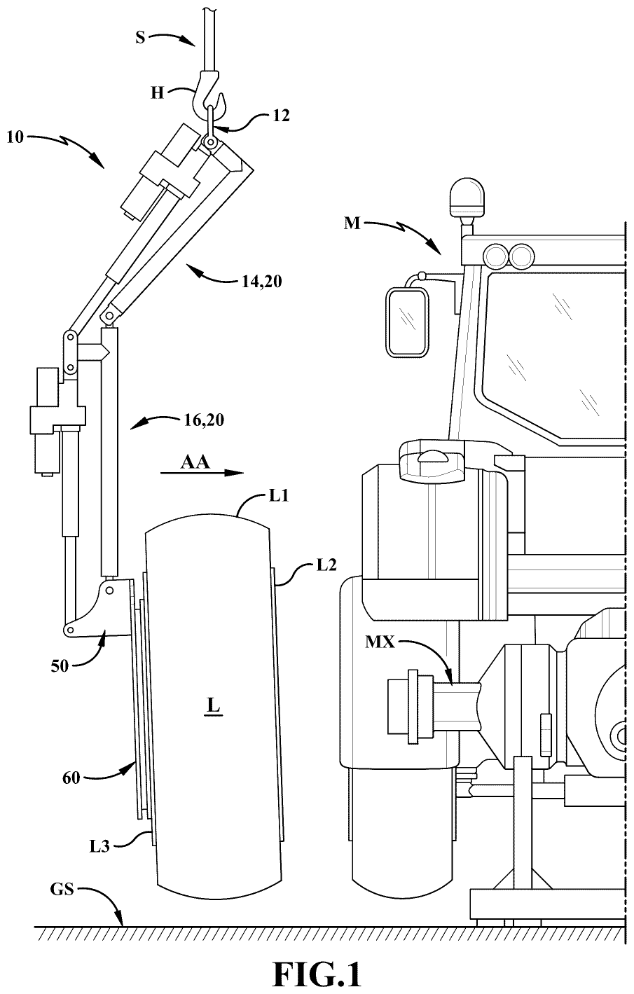

Referring to FIGS. 1-3C, there is shown a first embodiment of a vertical load balancer in accordance with the present disclosure, generally indicated at 10. Vertical load balancer 10 (which may also be referred to hereinafter as “load balancer 10”) generally comprises an attachment member 12, a first linkage assembly 14, and a second linkage assembly 16. First linkage assembly 14 and second linkage assembly form an articulating assembly 20. Load balancer 10 also comprises a support assembly 60. The articulating assembly 20 is configured to be operably engaged with attachment member 12 and with support assembly 60. Articulating assembly 20 enables the support assembly 60 to move relative thereto and relative to the attachment member 12. Support assembly 60 is configured to engage and secure a load “L” to load balancer 10. FIG. 1 shows load balancer 10 in use during the installation of the load “L” onto a piece of heavy machinery “M”. As illustrated, the load “L” is a tire which is being moved into position for installation onto an axel “MX” of a large dump truck, i.e., the heavy machinery “M”, in the direction of arrow “AA”. It will be understood that in other instances, the heavy machinery “M” could be any one of a number of different types of earth moving equipment other than a dump truck. The machinery “M” could also be any other piece of equipment onto which a component, i.e., load “L”, needs to be installed or from which load “L” needs to be removed. In yet other instances the load “L” may be any large, heavy component or piece of equipment which is to be installed on or removed from any other type of machinery “M”.

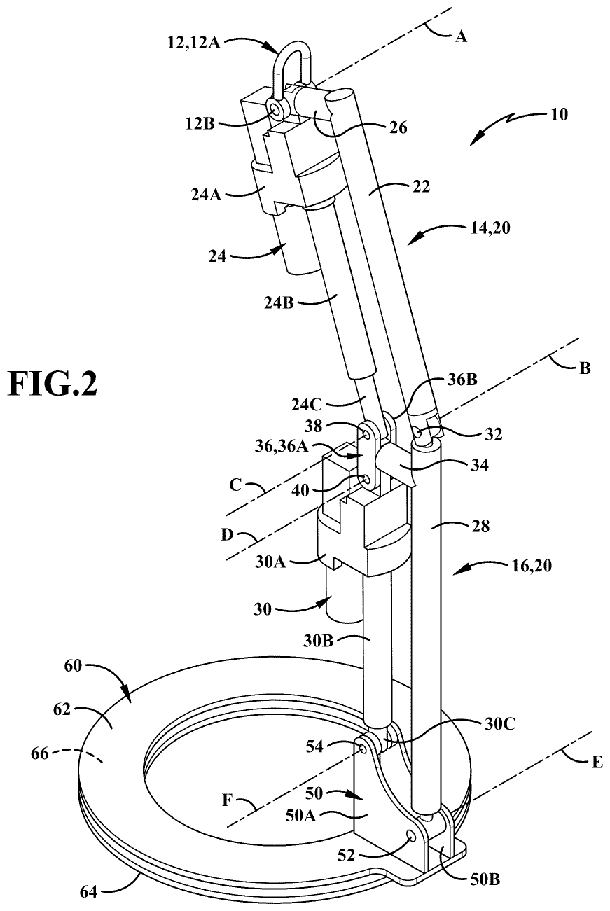

FIG. 1 shows load “L” is a large tire which has a circumferential wall “L1”, a first side wall “L2”, and a second side wall “L3”. The first and second side walls “L2”, “L3” are located opposite one another and are spaced laterally apart from one another. First side wall “L2” and second side wall “L3” are integral with circumferential wall “L1”. FIG. 1 shows load balancer 10 suspended from part of an exemplary support mechanism “S” via the attachment member 12. In one embodiment, the support mechanism may be a crane. The part of the support mechanism “S” illustrated in FIG. 1 includes a cable with a hook “H” attached at one end. The other end of the cable is secured to the crane and the crane is operable to raise, lower, and otherwise manipulate the load balancer 10. It will further be understood that the support mechanism “S” may be any system other than a crane which is capable of being engaged with load balancer 10 and is operable to manipulate the same. The attachment member 12, as illustrated in FIG. 1 comprises an attachment link 12A and a pivot rod 12B. The pivot rod 12B secures the attachment link 12A to articulating assembly 20. Attachment link 12A and articulating assembly 20 are pivotable relative to one another about a first pivot axis “A” (FIG. 2). Attachment link 12A is configured to receive the hook “H” therethrough to engage load balancer 10 with support mechanism “S”.

It will be understood that in other instances, attachment member 12 may take a configuration other than the illustrated attachment link 12A and first pivot rod 12B. Any configuration of attachment member 12 suitable for securely engaging load balancer 10 to support mechanism “S” may be utilized. So, for example, the attachment member 12 may comprise or include a chain, a strap, a binder, a bolt or any other suitable connector for securing load balancer 10 to support mechanism “S”.

Referring to FIGS. 1 and 2, as indicated earlier herein, articulating assembly 20 comprises first linkage assembly 14 and second linkage assembly 16. First linkage assembly 14 comprises a first arm 22 and a first actuator 24 arranged parallel to and opposite one another. First actuator 24 comprises a first motor 24A, a first body 24B and a first piston rod 24C configured to be extended outwardly from first body 24B and/or to be withdrawn inwardly into first body 24B. First piston rod 24C is therefore configured to be selectively movable one of into and out of first body 24B when actuated by first motor 24A. First linkage assembly 14 of articulating assembly 20 further comprises a first member 26 extending between and connecting ends of first arm 22 and first actuator 24 to one another. A first end of first member 26 engages and connects with first arm 22 and a second end of first member 26 engages and connects with first actuator 24. Pivot rod 12B secures attachment link 12A of attachment member 12 to first member 26 of first linkage 14 via first pivot rod 12B.

As indicated above, the articulating assembly 20 further comprises second linkage assembly 16 which includes a second arm 28 and a second actuator 30 arranged parallel to and opposite one another. Second actuator 30 comprises a second motor 30A, a second body 30B and a second pivot rod 30C. Second piston rod 30C is configured to be selectively movable one of into and out of second body 30B when actuated by second motor 30A. First arm 22 of first linkage assembly 14 and second arm 28 of second linkage assembly 16 are pivotally engaged with one another via a second pivot rod 32. First arm 22 is rotatable relative to second arm 28 about second pivot rod 32 and along axis “B” (FIG. 2). Pivot axes “A” and “B” are arranged parallel to one another and are spaced a distance apart from one another. In one specific embodiment, first actuator 24 and second actuator 30 are high force electric linear actuators.

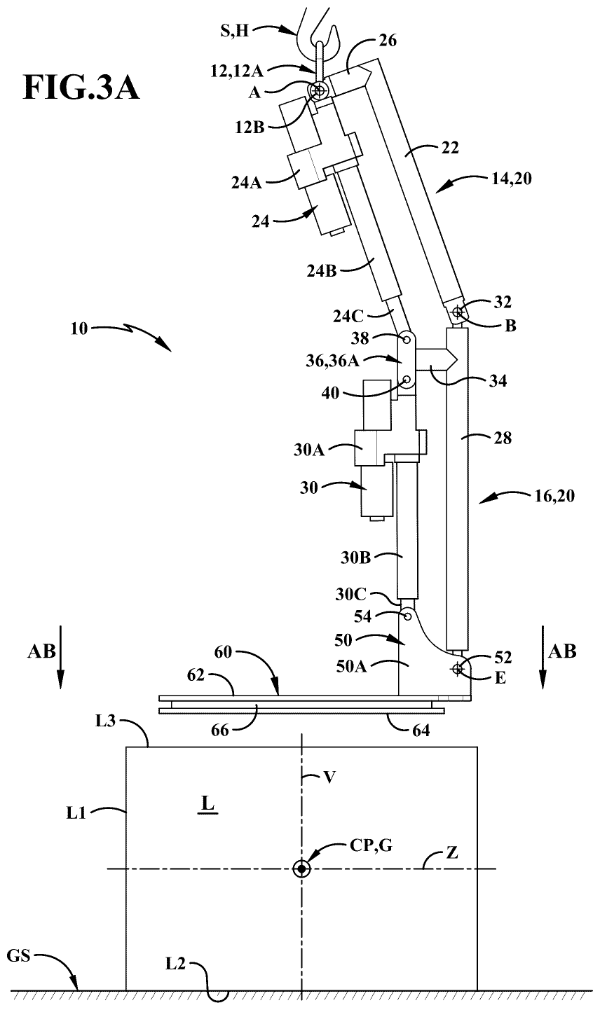

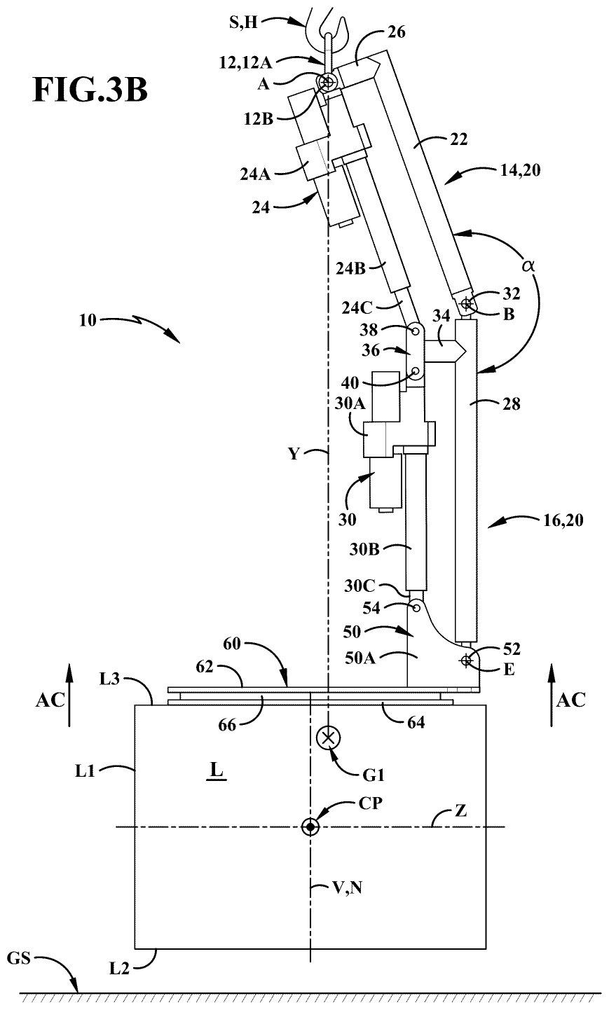

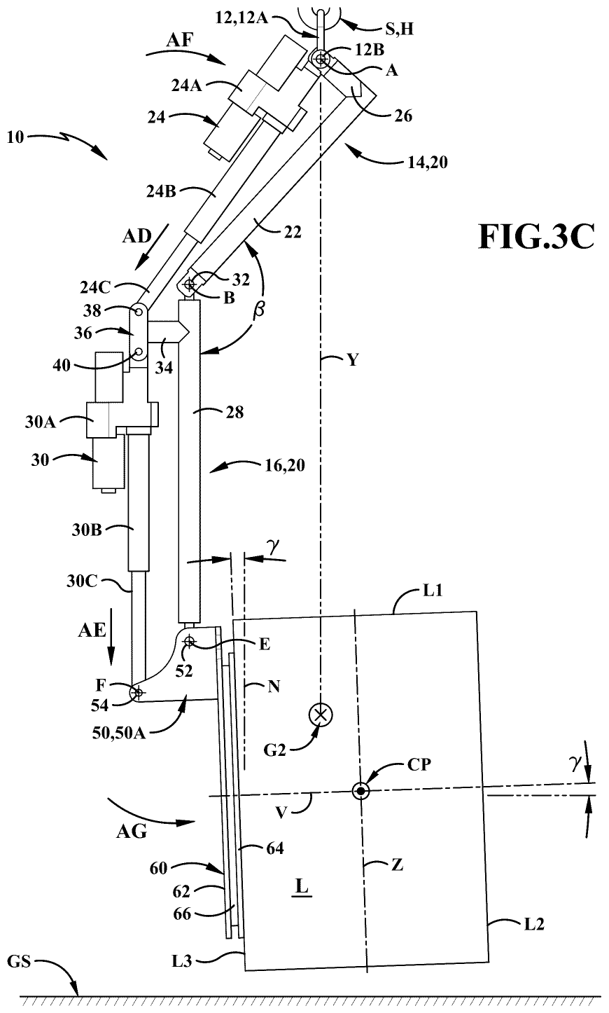

First actuator 24 and second actuator 30 are connected to one another via a first link 36. As best seen in FIG. 2, first link 36 comprises a first plate 36A and a second plate 36B located spaced apart and opposite to one another. A second member 34 extends outwardly from second arm 28 and is received between and secured to first plate 36A and second plate 36B. First actuator 24, second actuator 30 and second member 34 meet and engage one another via first plate 36A and second plate 36B of first link 36. First actuator 24 engages with first link 36 via a third pivot rod 38. First actuator 24 is rotatable about third pivot rod 38 along axis “C” (FIG. 3). Second actuator 30 engages with first link 36 via a fourth pivot rod 40. Second actuator 30 is rotatable about fourth pivot rod 40 along axis “D” (FIG. 3). Axes “C” and “D” are parallel to one another and to axes “A” and “B”.

Articulating assembly 20 further comprises a connector 50 configured to connect articulating assembly and support assembly 60 to one another. Specifically, connector 50 is configured to engage second linkage assembly 16 of articulating assembly 20 to support assembly 60. As best seen in FIG. 2, connector 50 comprises a first plate 50A and a second plate 50B located parallel to and opposite one another and spaced a distance laterally apart from one another. Second arm 28 of second linkage 16 is secured to connector 50 between first plate 50A and second plate 50B via a fifth pivot rod 52. Connector 50 is rotatable relative to second arm 28 about fifth pivot rod 52 and along axis “E” (FIG. 3). Second actuator 30 is secured to connector 50 between first plate 50A and second plate 50B via a sixth pivot rod 54. Connector 50 and second actuator 30 are rotatable relative to one another about sixth pivot rod 54 and along axis “F” (FIG. 2). Axes “E” and “F” are parallel to one another and are parallel to axes “A”, “B, “C”, and “D”.

Referring to FIG. 2, support assembly 60 comprises a first ring 62 and a second ring 64 located parallel and opposite one another and spaced laterally apart from one another. Support assembly 60 further comprises a third ring 66 extending between and connecting first ring 62 and second ring 64. Third ring 66 enables selective relative rotation between first ring 62 and second ring 64. Second assembly 60 is adapted to engage and secure thereto so as to enable load balancer 10 to lift and move the load “L”. i.e., to articulate the load “L”, to a desired orientation and position. In one embodiment, support assembly 60 comprises an electromagnet which can engage and secure load “L” thereto through magnetic force. The electromagnet forms a magnet assembly that is provided on the support assembly 60. The magnet assembly generates a magnetic field and attracts the load “L” to the support assembly 60 via the magnetic field. In another embodiment, support assembly 60 may be configured to generate a vacuum to secure load “L” thereto. In yet another embodiment support assembly 60 may be engaged with load “L” via a clamping mechanism or some other mechanical fastening assembly such as a hook and pin type connector.

Having now described load balancer 10, a method of using load balancer 10 to manipulate load “L” will be described with reference particularly to FIGS. 1 and 3A to 3C. Referring to FIGS. 1 and 3A, load balancer 10 is engaged with support mechanism “S” by way of hook “H” being engaged with attachment member 12. A user actuates support mechanism “S” and lowers load balancer 10 in the direction indicated by arrows “AB” in FIG. 3A to place support assembly 60 in contact with load “L”. Load “L” is oriented such that first side wall “L2” thereof is in contact with a ground surface “GS” and second side wall “L3” thereof is located a distance vertically above first side wall “L2”. FIG. 3A further shows that load “L” defines an imaginary centerline “V” which passes through a center point “CP” of load “L” and is equidistant in all radial directions from the circumferential wall “L1”. Load “L” further defines an imaginary midline “Z” which passes through center point “CP” of load “L” and is equidistant from first side wall “L2” and second side wall “L3”. Imaginary centerline “V” and imaginary midline “Z” intersect one another at the center point “CP” of the load “L”. When load “L” rests on the ground surface “GS” as illustrated in FIG. 3A, the load “L” has a center of gravity “G” which is located at center point “CP”.

Referring still to FIG. 3A, when load balancer 10 is actuated, second ring 64 of support assembly 60 is moved downwardly towards ground surface “GS” until second ring 64 is contacts second side wall “L3” of load “L”. Support assembly 60 is actuated to secure “L” thereto. For example, support assembly 60 is actuated to generate a vacuum condition between second ring 64 and second side wall “L3” and thereby secure load “L” to support assembly 60 via vacuum. It will be understood that any other suitable manner of securing load “L” to support assembly 60 may be employed depending on the nature of the load “L”.

Referring now to FIG. 3B, load balancer 10 is shown in a first position where load “L” is engaged with and secured to support assembly 60. Load balancer 10 in first position defines a first angle “α” between first arm 22 of first linkage assembly 14 and second arm 28 of second linkage assembly 16. First angle “α”, as illustrated, is greater than 180 degrees. It will be understood that first angle “α” may be equal to 180 degrees. First linkage assembly 14 and second linkage assembly 16 are therefore arranged relative to one another at an angle of about 180 degrees in the first position. Once load balancer 10 is secured to load “L”, support mechanism “S” is actuated to lift load “L” vertically off the ground surface “GS”. Load “L” is retained in this first position at substantially a same orientation as when load “L” rested on ground surface “GS”. In this orientation, the support assembly 60 is oriented at 90 degrees to the centerline “V” of load “L”. Stated differently, support assembly 60 is oriented at ninety degrees relative to Normal “N”. The lifting of load “L” is indicated by arrows “AC” in FIG. 3B. Load balancer 10 and load “L”, together, have a combined center of gravity “G1” which is substantially vertically aligned along a axis “Y” (FIG. 3B) extending through attachment member 12. As is evident from FIG. 3B, when load “L” is lifted off the ground surface “GS”, the combined center of gravity “G1” of load balancer 10 and load “L” translates away from center point “CP” and towards load balancer 10. FIG. 3B shows the center point “CP” moved vertically upwardly away from center point “CP” and midline “Z”, and laterally away from imaginary centerline “V” in a direction towards load balancer 10.

It will be understood that the position of the center of gravity “G” of load “L” on its own and the position of the center of gravity “G1” of the combined load balancer 10 and load “L” shown in FIGS. 3A and 3B are exemplary only. The exact positions of the centers of gravity “G” and “G1” will depend upon the configuration and weight of the load “L”, the combined configuration and weight of load balancer 10 plus the load “L”, and whether the load balancer 10 is in a first position or a second position.

To engage load “L” with machinery “M” (FIG. 1) load balancer 10 is articulated between the first position shown in FIG. 3B into a second position or a desired position shown in FIG. 3C by manipulating one or both of first actuator 24 and second actuator 30. First actuator 24 is manipulated by engaging first motor 24A to selectively extend first rod 24C outwardly from first body 24B or retract first rod 24C inwardly towards first body 24B as is needed and as is indicated by arrow “AD. Second actuator 30 is manipulated by engaging second motor 30A to selectively extend second rod 30C outwardly from second body 30B or retract second rod 30C inwardly towards second body 30B as is needed and as is indicated in the direction of arrow “AE”. In particular to articulate from the first position to the second position, first rod 24C is extended outwardly from first body 24B (FIG. 3C) and second rod 30C IS extended outwardly from second body 30B. The manipulation of first actuator 24 causes first linkage assembly 14 to pivot relative to second linkage assembly 16 about third pivot rod 38 and in the direction indicated by arrow “AF”. The manipulation of second actuator 30 causes connector 50 and thereby support assembly 60 (and thereby load “L”) to pivot relative to second linkage assembly 16 about fifth pivot rod 52 and in the direction indicated by of arrow “AG”. It should be noted that during articulation between the first position and the second position, second arm 28 and second member 34 remain substantially stationary while first arm 22, first actuator 24, second actuator 30, connector 50 and support assembly 60 move. Load balancer 10, when in the second position, defines a second angle “β”, being the angle between first arm 22 of first linkage assembly 14 and second arm 28 of second linkage assembly 16. Second angle “β” is less the first angle “α”. As illustrated in FIG. 3C, second angle “β” is less than about 180 degrees. Load balancer 10 in the second position defines a third angle “γ” as the angle between centerline “V” of load “L” and a horizon of the ground surface “GS”. In one specific embodiment, the third angle “γ” is equal to about 2 degrees. When load balancer 10 is articulated from the first position and into the second position, the support assembly 60 moves through about ninety degrees from a generally horizontal orientation (shown in FIGS. 3A and 3B) to a generally vertical orientation (shown in FIG. 3C). In particular, the support assembly 60 when in the second position will be oriented at about the third angle “γ” relative to Normal “N”.

As load balancer 10 is articulated into second position the center of gravity of the combined load balancer 10 and load “L” shifts relative to the position of the center of gravity “G1” when load balancer 10 was in the first position (FIG. 3B). As shown in FIG. 3C, when load balancer 10 is in the second position, the center of gravity “G2” of the combined load balancer 10 and load “L” stays substantially vertically aligned along the axis “Y” extending through attachment member 12. The center of gravity “G2” is in a different location relative to the location of the center of gravity “G1” when load balancer was in the first position shown in FIG. 3B.

If, as IS shown in FIG. 1, the load “L” is a tire which is to be installed on machinery “M”, the load balancer 10 is articulated into the second position (FIG. 3C) or into any other suitable position so as to align the tire “L” in a position suitable to install the tire onto the axle “MX” of the vehicle “M”. If the tire “L” is manipulated via the support mechanism “S” into a position to be engaged on the axle “MX” it may be found that the particular orientation of the second position of load balancer 10 and therefore of the tire “L” is not correct. The operator will actuate one or both of the first actuator 24 and second actuator 30 to adjust the orientation of the load balancer 10 and thereby the orientation of the load “L” to one more suitable for engagement of the load “L” with the axel “MX”. The arrangement of the first linkage assembly 14 and second linkage assembly 16 thus enables the operator to readily and easily change the orientation of the load “L” to one suitable for securing the load “L” to the machinery “M”.

Once the load “L” is suitably engaged with the axel “MX”, the mechanism for securing the load balancer 10 to the load “L” is disengaged. For example, the vacuum condition applied by support assembly 60 to load “L” is broken so that the load “L” is no longer retained in secure engagement with support assembly 60. Load balancer 10 is then moved by support mechanism “S” away from the machinery “M” and the operator will take whatever action is appropriate to secure the tire “L” to the machinery “M”.

Because of the articulation between first linkage assembly 14 and second linkage assembly 16, and between second linkage assembly 16 and support assembly 60, load balancer 10 may be utilized to not only engage a load “L” which is resting on the ground surface “GS” but can also be used to engage loads in other orientations and locations. For example, it will be understood that load balance 10 may also be utilized to aid an operator in removing a load, such as the tire “L”, from a piece of equipment such as vehicle “M”. If this is required, the operator will move the load balancer 10 into the second position (FIG. 3C) and manipulate the support mechanism “S” to bring the support assembly 60 into close proximity with the load “L” mounted on machinery “M”. In particular, the operator will manipulate the support mechanism “S” to place the second ring 64 of support assembly 60 into abutting contact with the second side wall “L3” of the load “L”. The operator will then actuate load balancer 10 to create a vacuum condition between second ring 64 and side wall “L3” to engage and secure the load “L” to load balancer 10. The support mechanism “S” can then be manipulated to withdraw the load “L” from the machinery “M” while maintaining the load balancer 10 in the second position. Once the load “L” is clear of the machinery “M” the operator is able to actuate the load balancer 10 to move the same from the second position (FIG. 3C) to the first position (FIG. 3B). The operator will then operate support mechanism “S” to lower the load “L” back onto the ground surface “GS” and will then release the engagement mechanism which secures load “L” to load balancer 10. For example, the vacuum condition may be disengaged to release load “L” from load balancer 10.

In one specific embodiment, support assembly 60 may be a slew bearing.

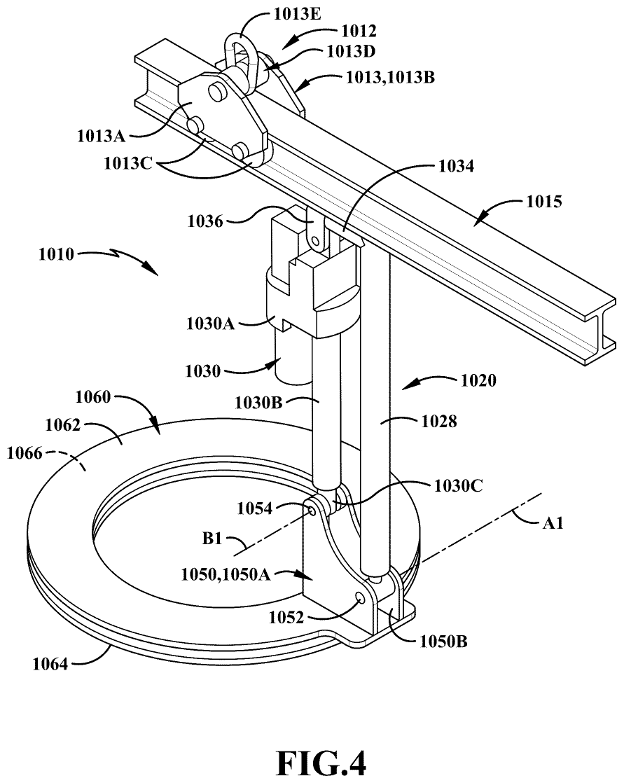

Referring now to FIGS. 4-8, there is shown a second embodiment of load balancer in accordance with an aspect of the present disclosure, generally indicated at 1010. Load balancer 1010 may also be referred to hereinafter as a “single load manipulator 1010”. Load balancer 1010 may also be referred to hereinafter as a “single load effector 1010”. Load balancer 1010 is substantially identical in function to load balancer 10 but differs in some structural elements relative to load balancer 10. The differences in the structural components of load balancer 1010 will be discussed hereafter.

Referring to FIG. 4, load balancer 1010 comprises an attachment member 1012, an articulating assembly 1020 and a support assembly 1060 Attachment member 1012 is differently configured relative to attachment member 12 of load balancer 10. Articulating assembly 1020 is also differently configured relative to articulating assembly 20 of load balancer 10. Attachment member 1012 and articulating assembly 1020 will be described in further detail later herein.

Support assembly 1060 is identical in function and structure to support assembly 60 of load balancer 10 and will therefore not be described in much further detail herein other than to say support assembly 1060 comprises a first ring 1062, a second ring 1064, and a third ring 1066.

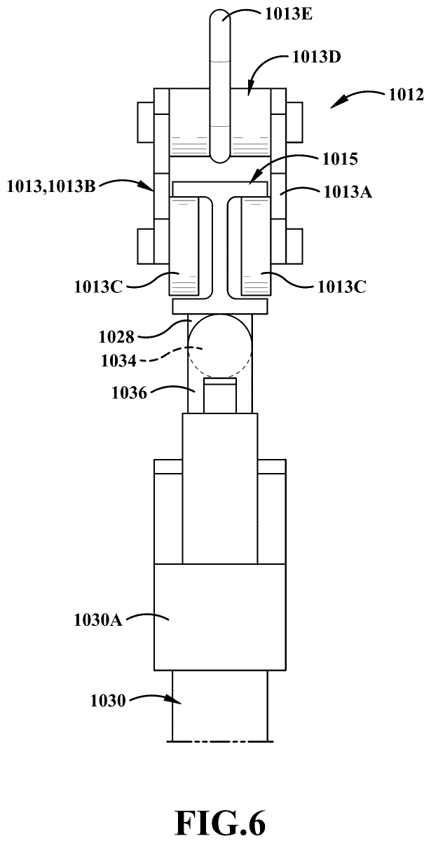

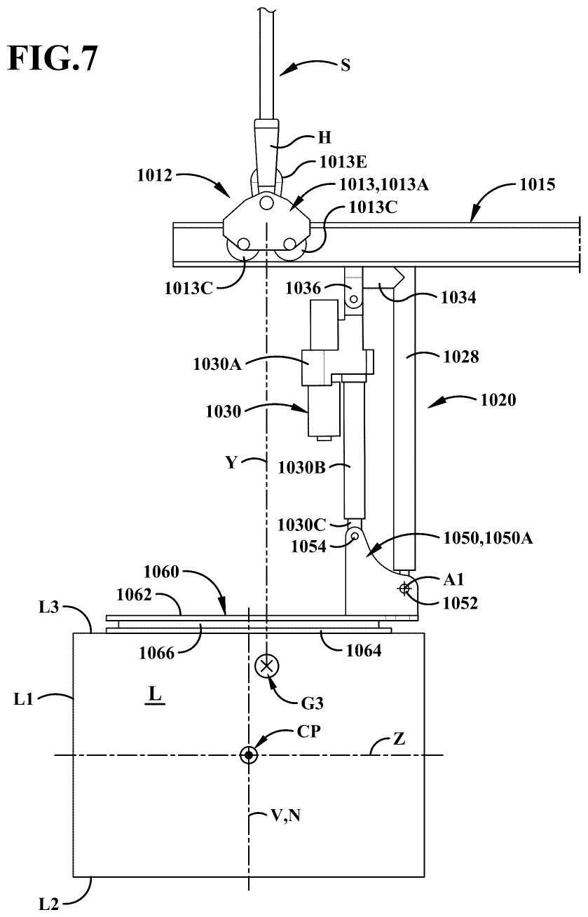

Attachment member 1012 is configured to receive a hook “H” (FIG. 7) which is engaged at an end of a cable extending downwardly from a crane. The crane, cable, and hook “H”, together, comprise a support mechanism “S” for load balancer 1010. Attachment member 1012 is suspended from support mechanism “S”. Attachment member 1012 comprises a trolley 1013 and a beam 1015 along which trolley 1013 is selectively reciprocally movable. As best seen in FIGS. 4 and 6, beam 1015 is an I-beam (or I-strut) comprising a vertically oriented web with an upper flange at a top end of the web and a lower flange at a bottom end of the web. It will be understood, however, that other configurations of beam 1015 can be utilized in attachment member 1012 without departing from the scope of the present disclosure.

As best seen in FIG. 6, trolley 1013 includes a pair of spaced-apart plates 1013A, 1013B and a plurality of sets of wheels 1013C rotatably engaged with plates 1013A, 1013B. Trolley 1013 further comprises a securement element 1013D extending between the pair of spaced-apart plates 1013A, 1013B and to which an attachment link 1013E is secured. Trolley 1013 is operatively engaged with support beam 1015 in that the web of the beam 1015 is received between the plates 1013A, 1013; the upper flange is located above a top region of the wheels 1013C, and the lower flange is located below the wheels 1013C. This arrangement can be seen in FIG. 6. As stated earlier herein, trolley 1013 is configured to be selectively reciprocally movable along support beam 1015 in one of a first direction and a second direction.

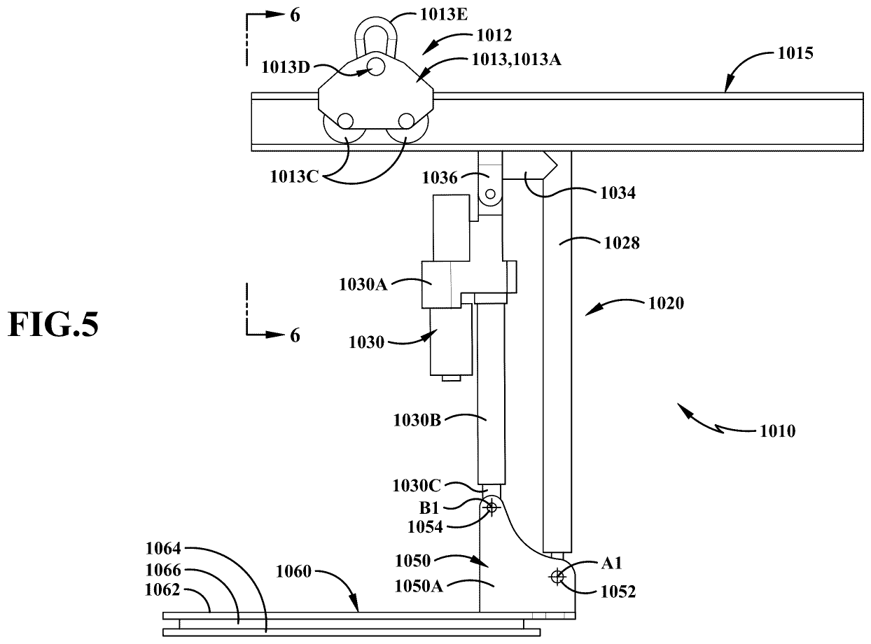

Referring to FIG. 5, articulating assembly 1020 comprises a single linkage assembly comprising a first arm 1028 and a first actuator 1030 located opposite one another. First actuator 1030 comprises a first motor 1030A, a first body 1030B and a first rod 1030C configured to be selectively extended outwardly from first body 1030B via first motor 1030A or retracted inwardly into first body 1030B via first motor 1030A. First arm 1028 and first actuator 1030 are substantially identical in structure to second arm 28 and second actuator 30 of load balancer 10. Articulating assembly 1020 further comprises a first member 1034 extending between and connecting first arm 1028 and first actuator 1030 to one another.

Referring to FIG. 5, articulating assembly 1020 and attachment member 1012 are nonremovably secured to one another. Specifically, the first member 1034, the upper end of first arm 1028 and a link member 1036 are welded or otherwise secured to the lower flange of beam 1015. First member 1034, link member 1036, the upper end of first arm 1028, and beam 1015 therefore form a unitary component. Articulating assembly 1020 further comprises a connector 1050 configured to engage support assembly 1060. Specifically, connector 1050 is configured to engage a second end of first arm 1028 and the first rod 1030C of first actuator 1030 to support assembly 1060. Connector 1050 comprises a first plate 1050A and a second plate 1050B located opposite one another and spaced a distance laterally apart. First arm 1028 engages and connects with connector 1050 between first plate 1050A and second plate 1050B via a first pivot rod 1052. Connector 1050 is rotatable relative to first arm 1028 about first pivot rod 1052 along axis “A1” (FIG. 4). First rod 1030C of first actuator 1030 engages and connects with connector 1050 between first plate 1050A and second plate 1050B via a second pivot rod 1054. First actuator 1030 and connector 1050 are rotatable relative to one another about second pivot rod 1054 along axis “B1” (FIG. 4).

Referring to FIGS. 4 and 5, support assembly 1060 is configured to engage and secure load “L” to load balancer 1010 in order to enable load balancer 1010 to lift and move the load “L”. i.e., to articulate the load “L”, to a desired orientation and position. Load balancer 1010 may be actuated to secure load “L” thereto via vacuum, magnetic attraction, a clamping mechanism or any other suitable mechanism or method.

Having now described load balancer 1010, a method of using load balancer 1010 to manipulate load “L” will be described.

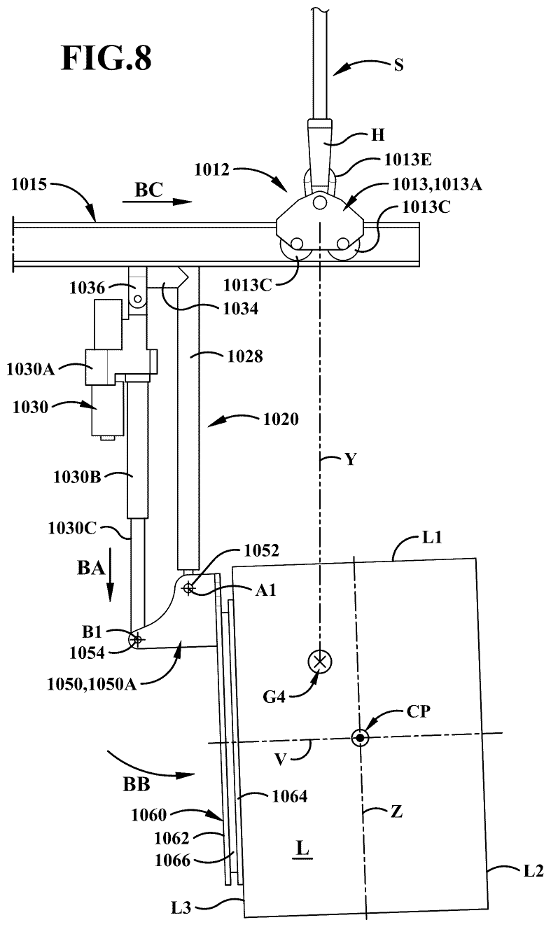

Referring now to FIGS. 7 and 8, load balancer 1010 is shown engaged with load “L”. Trolley 1013 is engaged to a support mechanism “S” by hook “H” being received through the attachment link 1013E. When the attachment link 1013E is engaged with hook “H” load balancer 1010 is suspended from the support mechanism “S” via the attachment member 1012. FIG. 7 shows load balancer 1010 in a first position where support assembly 1060 is oriented at ninety degrees to Normal “N”. (Normal is oriented aligned with the centerline “V” of load “L” and is oriented orthogonally to midline “Z” of load “L”). Load balancer 1010 and load “L”, together, have a center of gravity “G3” located on load “L” and substantially aligned with a vertical axis “Y” (FIG. 7) extending along the cable attached to hook “H”.

Load balancer 1010 is actuated to articulate support assembly 1060 and thereby load “L” from the first position (FIG. 7) and into a second position or a desired position (FIG. 8) by manipulating first actuator 1030. First actuator 1030 is manipulated by activating first motor 1030A to extend first rod 1030A outwardly from first body 1030B in the direction of arrow “BA”. The extension of first rod 1030A outwardly from first body 1030B causes connector 1050 to be pivot about second pivot rod 1054 in the direction indicated by arrow “BB” in FIG. 8, thereby pivoting support assembly 1060 and load “L” in the direction indicated by arrow “BB”. The first arm 1028 remains substantially stationary when first rod 1030C is extended outwardly from first body 1030B and connector 1050 and support assembly 1060 move to the second position. As load balancer 1010 is articulated into the second position, or any other position, the center of gravity of the combined load balancer 1010 and load “L” shifts in location. For example, the center of gravity “G4” of the combined load balancer 1010 and load “L” is shown in FIG. 8 in a different position relative to the center of gravity “G3” when support assembly 1060 and load “L” were in the first position (FIG. 7). To keep the combined load balancer 1010 and load “L” balanced, trolley 1013 travels along beam 1015 in the direction indicated by arrow “BC” in FIG. 8. The center of gravity of the combined load balancer (single load manipulator) 1010 and load “L” will be substantially aligned along the axis “Y” extending along the attachment link 1013E and the cable of the securement mechanism “S” at all times, i.e., as the center of gravity shifts as the load “L” is articulated by the load balancer 1010, the trolley 1013 rides along beam 1015, thereby substantially continuously keeping the center of gravity aligned along axis “Y”. trolley 1013. It will be understood that if it is desired to return the load balancer 1010 to the first position either after the load “L” has been disengaged from support assembly 1060 or while the load “L” is still secured to support assembly 1060, the above-described steps are simply reversed. The motor 1030A is actuated to withdraw the first rod 1030C into the first body 1030B. The retraction of the first rod 1030C pivots the connector 1050 and thereby the support assembly 1060 (and load “L” if still engaged) in the opposite direction to arrow “BB” (FIG. 8). As the support assembly pivots about the second pivot rod 1054, trolley 1013 travels along beam 1015 in the opposite direction to arrow “BC”, continuously keeping the center of gravity of the load balancer 1010 and load “L” if attached aligned with the axis “Y” extending along the cable of the support mechanism “S”.

It will be understood that while the trolley 1013 as described above moves in response to the shifting of the center of gravity of the combined load balancer 1010 and load “L”, in other embodiments a cable may extend from the trolley 1013 to the second linkage assembly 1016 or to the support assembly 1060 and movement of the trolley 1013 may aid in moving support assembly 1060 between the first position and the second position. The trolley may move because the support mechanism “S” moves the trolley 1013 along the beam 1015 or because the trolley is provided with a motor (not shown) to effect such movement.

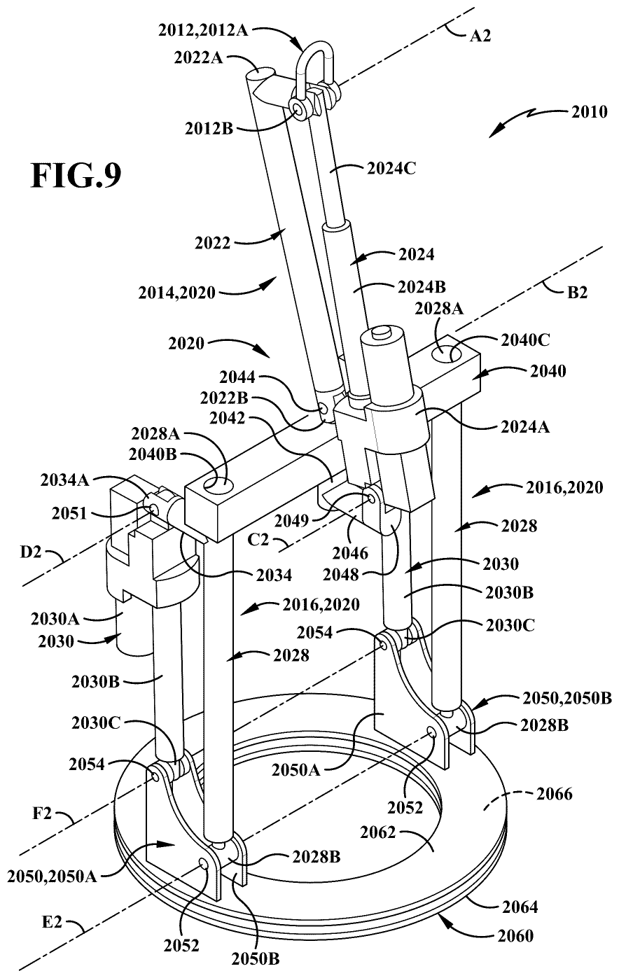

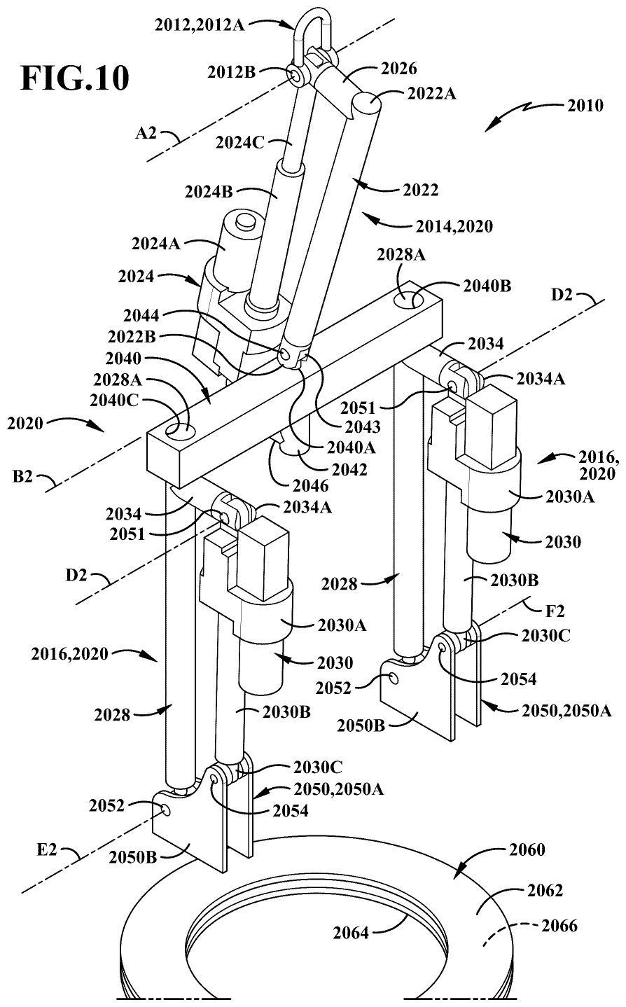

Referring now to FIGS. 9-11B, there is shown a third embodiment of a load balancer in accordance with an aspect of the present disclosure, generally indicated at 2010). Load balancer 2010 comprises an attachment member 2012, an articulating assembly 2020, and a support assembly 2060. Load balancer 2010 is substantially identical in function to load balancer 10 except for particular features which will be discussed hereafter. The structure of load balancer 2010 differs from load balancers 10 and 1010 as will be discussed hereafter. Attachment assembly 2012 is substantially identical in structure and function to attachment member 12 and therefore will not be described in any further detail herein. Attachment member 2012 comprises an attachment link 2012A and a first pivot rod 2012B which secures attachment link 2012A to articulating assembly 2020 and permits relative rotation between attachment link 2012A and articulating assembly 2020 along axis “A2” (FIG. 10). Support assembly 2060 is substantially identical in structure and function to support assembly 60 and therefore will not be described in much detail herein other than to state that support assembly 2060 comprises a first ring 2062 and a second ring 2064 located parallel and opposite one another and spaced laterally apart from one another. Support assembly 2060 further comprises a third ring 2066 extending between and connecting first ring 2062 and second ring 2064 to one another. Support assembly 2060 is configured to engage and secure load “L” thereto in order to enable load balancer 2010 to lift and articulate the load “L”, to a desired orientation and position. As with previous embodiments, any suitable mechanism or means for engaging and securing load “L” to support assembly 2060 may be utilized such as vacuum, magnetic attraction, and or mechanical means such as a clamping assembly.

Referring to FIGS. 9 and 10, articulating assembly 2020 of load balancer 2010 is differently configured to articulating assembly 20 and to articulating assembly 1020. Articulating assembly 2020 is configured to be operably engaged with attachment member 2012 and with support assembly 2060. The articulating assembly 2020 enables the support assembly 2060 to be moved relative to the attachment member 2012.

Referring to FIG. 9, articulating assembly 2020 comprises a first linkage assembly 2014 and a second linkage assembly 2016 which are operably engaged with one another. First linkage assembly 2014 is furthermore operably engaged with attachment member 2012 and second linkage assembly 2016 is operably engaged with support assembly 2060.

Referring still to FIGS. 9 and 10, first linkage assembly 2014 comprises a first arm 2022 and a first actuator 2024 located opposite one another. First arm 2022 has a first end 2022A and first clevis 2022B located opposite one another. First actuator 2024 comprises a first motor 2024A, a first body 2024B and a first rod 2024C configured to be selectively extended outwardly from first body 2024B via first motor 2024A or withdrawn inwardly into first body 2024B via first motor 2024A. Articulating assembly 2020 further comprises a first member 2026 extending between and connecting first arm 2022 and first actuator 2024 to one another. Specifically, first member 2026 extends outwardly from first end 2022a of first arm 2022 and connects with first rod 2024C of first actuator 2024 via a second clevis 2026A and first pivot rod 2012B.

Still referring to FIGS. 9 and 10, articulating assembly 2020 comprises a pair of laterally spaced apart second linkage assemblies 2016. The second linkage assemblies are identical in structure and function to one another. Each second linkage assembly comprises a second arm 2028 and a second actuator 2030 opposite one another. Second arm 2028 has a first end 2028A (FIG. 9) and third clevis or sleeve 2028B (FIG. 10) located opposite one another. Second actuator 2030 comprises a second motor 20230A, a second body 2030B and a second rod 2030C configured to extend outwardly from second body 2030B or be retracted inwardly into second body 2030B via second motor 2030A. Articulating assembly 2020 further comprises a second member 2034 (FIG. 10) extending between and connecting second arm 2028 and second actuator 2030. Specifically, second member 2034 extends outwardly from first end 2028A of second arm 2028 and connects with second actuator 2030 via a fourth clevis 2034A and a pivot rod 2051.

The second arms 2028 and second actuators 2030 of the pair of second linkage assemblies 2016 are substantially parallel to one another and work in unison with one another.

Referring to FIGS. 9 and 10, the first linkage assembly 2014 and the pair of second linkage assemblies 2016 are operably engaged with one another via a connector bridge 2040. In particular, the first arm 2022 and first actuator 2024 of first linkage assembly 2014 are operably engaged with the connector bridge 2040; and the second arm 2028 and second actuator 2030 of each of the second linkage assemblies 2016 is operably engaged with connector bridge 2040. As shown in FIG. 9, connector bridge 2040 defines a first aperture 2040A, a second aperture 2040B, and a third aperture 2040C therein. Each aperture extends from an upper surface of the connector bridge to a lower surface thereof.

To secure first linkage assembly 2014 to connector bridge 2040, a barrel tube 2042 (FIG. 10) is inserted through the first aperture 2040A of connector bridge 2040 and extends for a distance above the upper surface and below the lower surface of connector bridge 2040. A rod end bolt 2043 is operably engaged with an upper end of barrel tube 2042 and is received in first clevis 2022B of first arm 2022 and may be retained therein by friction, and adhesive or any suitable fastening mechanism. A second pivot rod 2044 (FIG. 10) secures rod end bolt 2043 and thereby barrel tube 2042 and connector bridge 2040 to first clevis 2022B and thereby to first arm 2022. First arm 2022 is selectively rotatable relative to connector bridge 2040 about second pivot rod 2044 along axis “B2”. A tube 2046 (FIG. 9) is operatively engaged with a lower end of barrel tube 2042 located below the lower surface of connector bridge 2040. An actuator connector 2048 secures tube 2046 to first actuator 2024 via a third pivot rod 2049. First actuator 2024 is selectively rotatable relative to connector bridge 2040 about third pivot rod 2049 along axis “C2” (FIG. 9). The pair of second linkage assemblies 2016 are engaged with connector bridge 2040 in the following manner. A first end of the second arm 2028 of each second linkage assembly is inserted upwardly into an associated one of the second aperture 2040B and the third aperture 2040C of connector bridge 2040 from below the lower surface thereof. The first end of each second arm 2028 may be retained in engagement with the connector bridge 2040 by friction, by an adhesive, or by any other suitable fastening mechanism. Second actuator 2030 and second member 2034 of each second linkage assembly are engaged with connector bridge 2040 via second arm 2028, where second arm 2028 is nonremovably engaged with connector bridge 2040. Second actuator 2030 is selectively rotatable relative to second member 2034 about fourth pivot rod 2051 (FIG. 10) along axis “D2”.

Referring still to FIGS. 9 and 10, each of the second linkage assemblies 2016 of articulating assembly 2020 further comprises a connector 2050 configured to engage support assembly 2060. Specifically, connector 2050 is configured to engage second arm 2028 and second actuator 2030 of articulating assembly 2020 to support assembly 2060 in substantially the same manner as connector 50 engages second linkage assembly 16 to support assembly 60. Each connector 2050 comprises a first plate 2050A and a second plate 2050B located opposite one another and spaced a distance laterally apart. Second arm 2028 engages and connects with connector 2050 between first plate 2050A and second plate 2050B via a fifth pivot rod 2052. Specifically, third clevis 2028B of second arm 2028 engages and connects with connector 2050 between first plate 2050A and second plate 2050B via at a fifth pivot rod 2052. Connector 2050 is selectively rotatable relative to second arm 2028 about fifth pivot rod 2052 along axis “E2” (FIG. 10). Each second actuator 2030 engages and connects with connector 2050 between first plate 2050A and second plate 2050B via a sixth pivot rod 2054. Second actuator 2030 and connector 2050 are rotatable relative to one another about sixth pivot rod 2054 along axis “F2” (FIG. 10).

It will be understood that while connector bridge 2040 as illustrated herein is a rectangular cuboid in shape, the connector bridge to which first linkage assembly 2014 and the pair of second linkage assemblies 2016 are engaged may be configured in any way to suit a particular application of load balancer 2010. It will additionally be understood that more than a single first linkage assembly 2014 may be utilized in load balancer 2010, and fewer than two or more than two second linkage assemblies 2016 may be utilized in load balancer 2010 without departing from the scope of the present disclosure.

Having now described load balancer 2010, a method of using load balancer 2010 to manipulate load “L” will be described.

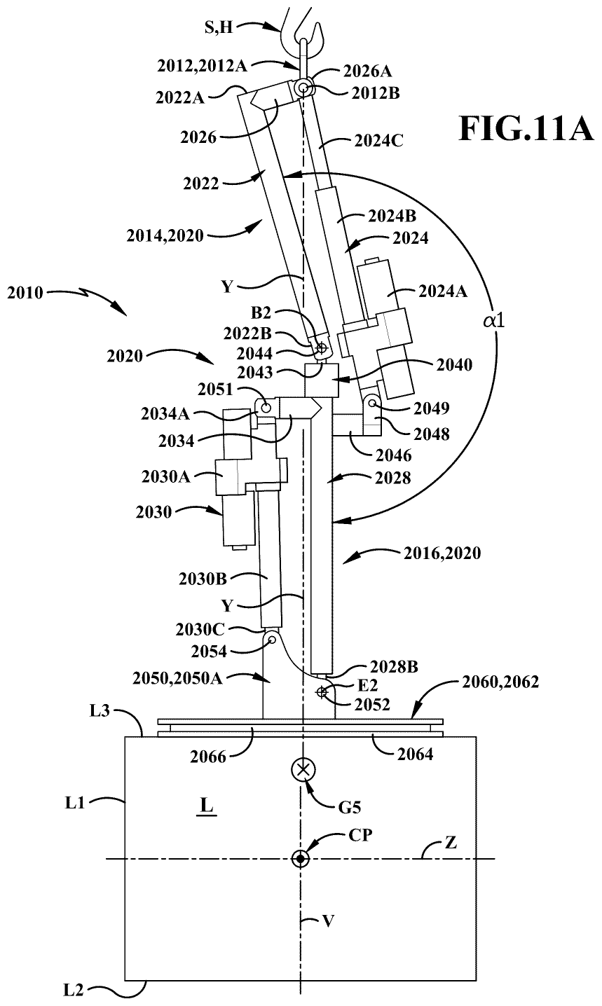

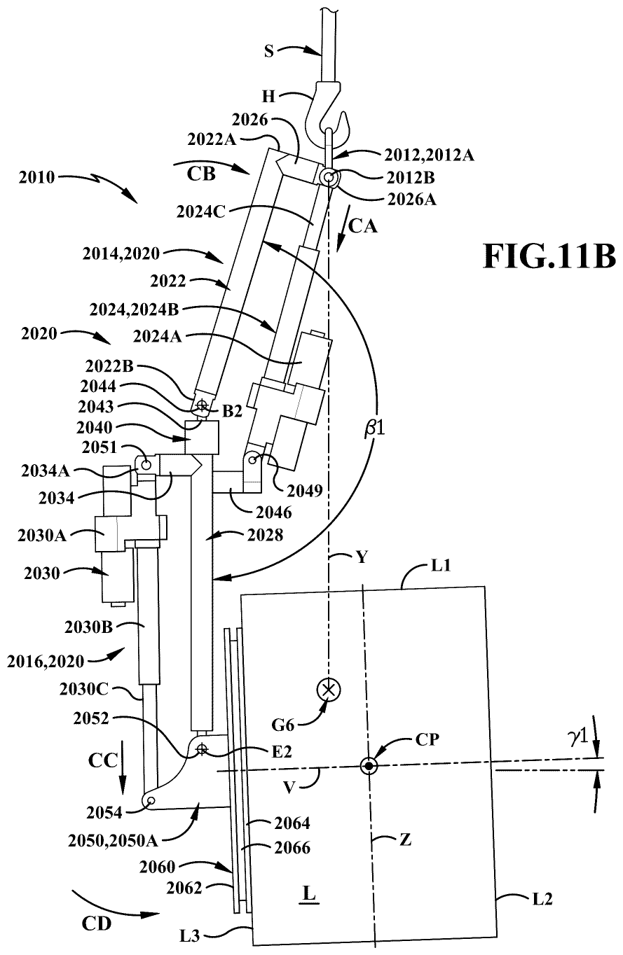

Referring now to FIG. 11A, load balancer 2010 is shown engaged with load “L” and attachment link 2012A of attachment member 1012 is engaged with hook “H” of support mechanism “S”. Load balancer 2010 is shown in a first position, i.e., where support assembly 2060 is oriented at right angles to Normal (not shown but previously discussed herein). Load balancer 2010 and load “L” together have a center of gravity “G5” located on load “L” and substantially aligned with attachment member 2012 along vertical axis “Y”. Load balancer 10 when in the first position defines a first angle “α1”, being the angle between first arm 2022 and second arm 2028. First angle “α1” is greater than or equal to about 180 degrees.

Referring now to FIG. 11B, load balancer 2010 is articulated into a second position or a desired position by manipulating one or both of the first actuator 2024 of first linkage assembly 2014 and the second actuators 2030 of the two second linkage assemblies 2016. The two second linkage assemblies operate substantially in unison with one another. As will be understood the first rod 2024C and the second rods 2030C may be extending outwardly from or retracted inwardly into the associated first body 2024B or 2030B. As shown in FIG. 11B, first actuator 2024 is manipulated by engaging first motor 2024A to retract first rod 2024C inwardly into first body 2024B in the direction indicated by arrow “CA”. The retraction of first rod 2024C causes rotation of first actuator 2024 about first pivot rod 2012B and rotation of first arm 2022 about second pivot rod 2044 as indicated by the arrow “CB”. Each second actuator 2030 is manipulated by engaging the associated second motor 2030A to extend the associated second rod 2030C outwardly from the respective second body 2030B in the direction indicated by arrow “CC”. Extension of the second rods 2030C causes connectors 2050 to rotate about sixth pivot rod 2054 as indicated by arrow “CD”, and the support assembly 2060 and thereby the load “L” are articulated to the second position shown in FIG. 11B. Load balancer 2010 in second position defines a second angle “β2 between first arm 2022 and second arm 2028. Second angle “β2” is less than about 180 degrees. Load balancer 2010 in the second position defines a third angle “γ1” as the angle between centerline “V” and midline “Z” of load “L”, where centerline “V” is oriented substantially parallel to the ground surface “GS”. In one specific embodiment, third angle “γ1” is equal to about 2 degrees.

As load balancer 2010 is articulated into the second position, the center of gravity shifts from the position “G5” shown in FIG. 11A to the position “G6” shown in FIG. 11B. The center of gravity of the combined load balancer 2010 and load “L” continuously stays substantially aligned with attachment member 2012 along vertical axis “Y”.

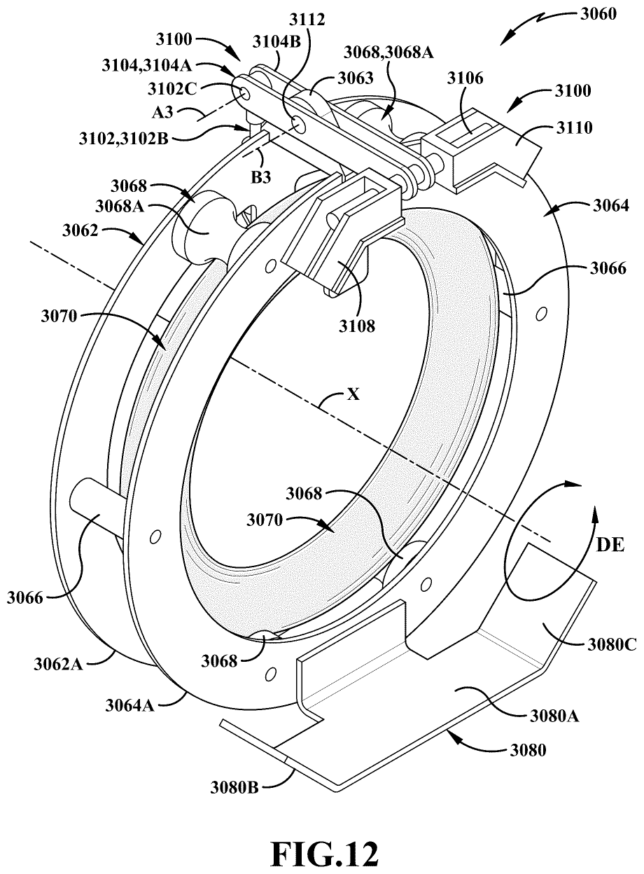

Referring now to FIGS. 12-18, there is shown a second embodiment of a support assembly in accordance with an aspect of the present disclosure, generally indicated at 3060. Support assembly 3060 can be used on any of the load balancers, disclosed herein in the place of the illustrated support assemblies illustrated in the attached figures.

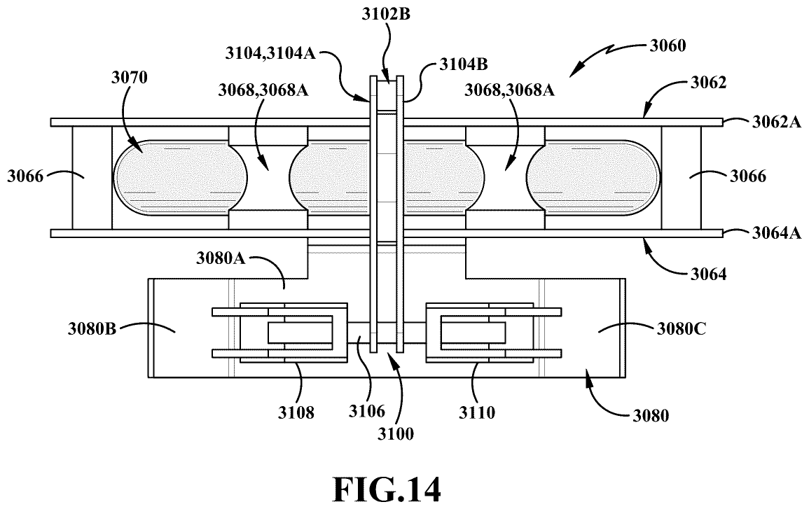

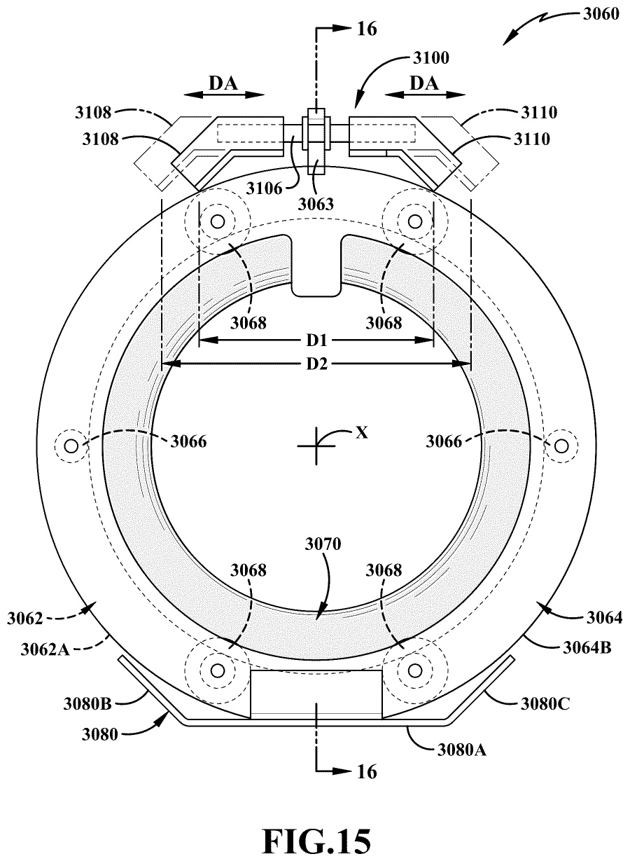

Referring to FIG. 12, support assembly 3060 comprises a first ring 3062 and second ring 3064 located parallel and opposite one another and spaced laterally apart from one another. Support assembly 3060 further comprises one or more tubular members 3066 extending between an inner surface of first ring 3062 and an inner surface of second ring 3064. Support assembly 3060 further comprises a plurality of rotators 3068 extending between the inner surface of the first ring 3062 and the inner surface of the second ring 3064. To tubular members 3066 are provided between first ring 3062 and second ring 3064. Tubular members 3066 are spaced circumferentially equidistant from one another. Support assembly includes four rotators 3068 arranged in circumferentially spaced apart pairs with the two pairs located opposite one another and separated by the tubular member 3066. This arrangement is best seen in FIG. 15. The rotators 3068 in the opposed pairs are aligned with one another. Referring now to FIG. 14, each rotator 3068 defines a circumferential or annular groove 3068A.

Referring to FIGS. 12-14, support assembly 3060 further comprises a cylindrical pipe 3070 placed between first ring 3062 and second ring 3064 and seated in the circumferential grooves 3068A of the four rotators 3068. The radius of curvature of the cylindrical pipe 3070 is substantially complementary to the radius of curvature of the concavely shaped circumferential groove 3068A of each rotator 3068.

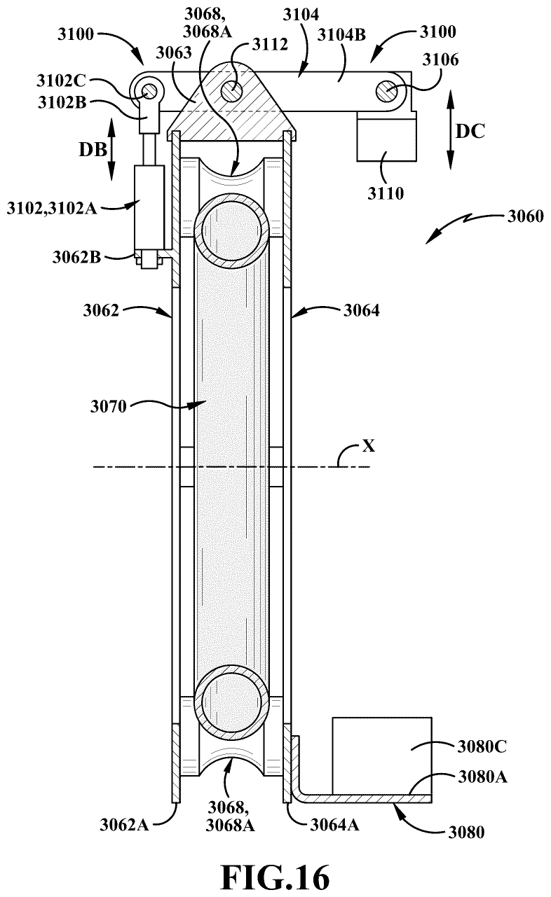

Referring to FIG. 12, support assembly 3060 further comprises a support plate 3080 which is secured to and extends outwardly from second ring 3064. In particular, the support plate 3080 is welded or otherwise secured to the outer surface of second ring 3064. The support plate 3080 is configured to receive and support at least a portion of load “L”, as will be described later herein support plate 3080 is generally an open U-shape, as is best seen in FIGS. 14 and 15, extends outwardly from outer surface 3062b of first ring 3062. FIGS. 12 and 15 show support plate 3080 comprises a first region 3080A, a second region 3080B, and a third region 3080C which are all located outwardly of the outer surface of second ring 3064. FIGS. 12 and 16 also show that the first, second, and third regions 3080A, 3080B, and 3080C of support plate 3080 are located generally aligned with or located slightly radially outwardly from a peripheral edge 3062A, 3064A of first ring 3062 and second ring 3064, respectively.

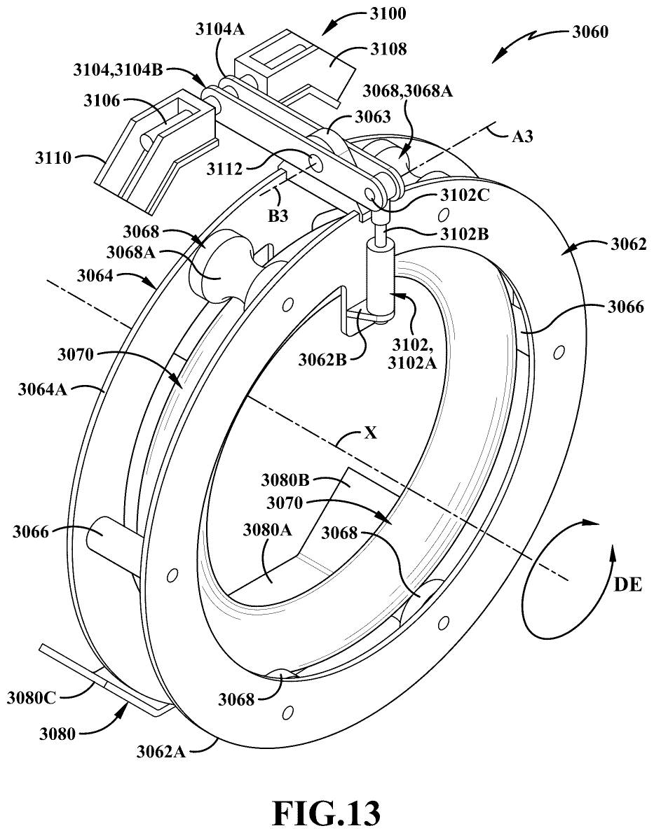

Support assembly 3060 further comprises a clamp assembly 3100 adapted to receive and secure at least a portion of load “L” in combination with support plate 3080. Clamp assembly 3100 and support plate 3080 are located opposed to one another when support assembly 3060 is viewed from the front as can be seen in FIG. 13. Referring now to FIGS. 13 and 14, clamp assembly 3100 comprises an air cylinder 3102, an arm 3104, a rod, 3106, a first jaw 3108 and a second jaw 3110. FIG. 13 shows a flange 3062B extends outwardly from the outer surface of first ring 3062. Air cylinder 3102 is mounted on flange 3062B and comprises a body 3102A and a piston rod 3102B. Air cylinder 3102 is actuatable to extend or retract piston rod 3102B relative to body 3102A. In one specific embodiment, air cylinder 3102 is a pneumatic round body cylinder.

A mounting bracket 3063 (FIGS. 13 and 16) is secured to and extends radially outwardly from the peripheral edges 3062A, 3064A of the first ring 3062 and second ring 3064. Arm 3104 comprises a first plate 3104A and a second plate 3104B which are located parallel and opposite to one another and are spaced a distance apart. A first end of each of the plates of arm 3104 is secured to piston rod 3102B of air cylinder 3102 by a first pivot pin 3102C. Arm 3104 is able to pivot relative to air cylinder 3102 about an axis “A3” extending along first pivot pin 3102C. A second pivot pin 3112 secures the two plates of arm 3104 to mounting bracket 3063. Second pivot pin 3112 acts as a fulcrum for the rotational motion of arm 3104 about an axis “B3” which extends along pivot pin 3112.

Rod 3106 extends through aligned holes (not numbered) defined proximate an end of the plates 3104A, 3104B of arm 3104. A first end of rod 3106 extends through a hole in first jaw 3108 of clamp assembly 3100. A second end of rod 3106 extends through a hole in second jaw 3110 of clamp assembly 3100. First jaw 3108 and second jaw 3110 are arranged on rod 3106 as mirror images of one another and are oriented opposite to one another. Other than their orientation, first jaw 3108 and second jaw 3110 are identical to one another. It will be understood that the following description of first jaw 3108 will apply equally to second jaw 3110. As best seen in FIG. 15, first jaw 3108 comprises a generally L-shaped housing 3108A and a clamp pad 3108B engaged with a surface of the housing located opposite the support plate 3080.

While the first jaw 3108 and second jaw 3110 are illustrated herein as both being L-shaped, this shape is exemplary only and, in other embodiment, jaws 3108, 3110 may be differently configured from one another or may be differently configured from what is illustrated in the attached figures. No matter the shape, clamp assembly's jaws 3108, 3110 are configured to be able to clampingly engage a load “L” in cooperation with the opposed support plate 3080 where the load is captured between clamping assembly 3100 and support plate 3080.

As is evident from FIG. 15, the position of first jaw 3108 and second jaw 3110 on rod 3106 is selectively adjustable to aid in clamping assembly 3100 to be customized to some degree to suit differently configured loads “L” to be engaged by support assembly 3060. FIG. 15 shows that first jaw 3108 and second jaw 3110 can slide relative to rod 3106 as indicated by arrows “DA” in FIG. 16. Jaws 3108, 3110 may be adjusted between a minimum distance “D1” between the outermost points of contact of the jaws with a load “L” to a maximum distance “D2” between the same outermost points. The outermost positions of the first jaw 3108 and second jaw 3110 are shown in phantom in FIG. 15. It will be understood that the longer the rod 3106, the further apart first jaw 3108 and second jaw 3110 may be moved relative to one another.

Having now described support assembly 3060, a method of using support assembly 3060 to secure load “L” will be described.

Referring now to FIG. 15, when an operator wishes to engage and secure load “L” to support assembly 3060, the operator will first set the relative position of first jaw 3108 and second jaw 3110 based on the shape and size of the exterior surface of load “L”.

Referring now to FIG. 16, support assembly 3060 may also be adjusted to vary the distance between clamping assembly 3100 and support plate 3080. This distance is adjusted by actuating air cylinder 3102 to selectively extend piston rod 3102C of air cylinder 3102 further outwardly from body 3102A thereof or retracting piston rod 3102C inwardly into body 3102A. This adjustment of piston rod 3102C relative to body 3102A is indicated in FIG. 16 by the arrows “DB”. Adjusting the piston rod 3102C relative to body 3102A causes arm 3104 to pivot about second pivot pin 3112 which selectively raises or lowers first and second jaws 3108, 3110 of clamping assembly 3100 as is indicated by arrow “DC”. Initially, the distance between clamping assembly 3100 and support plate 3080 must be slightly larger than the diameter of the load “L” to be engaged with support assembly 3060.

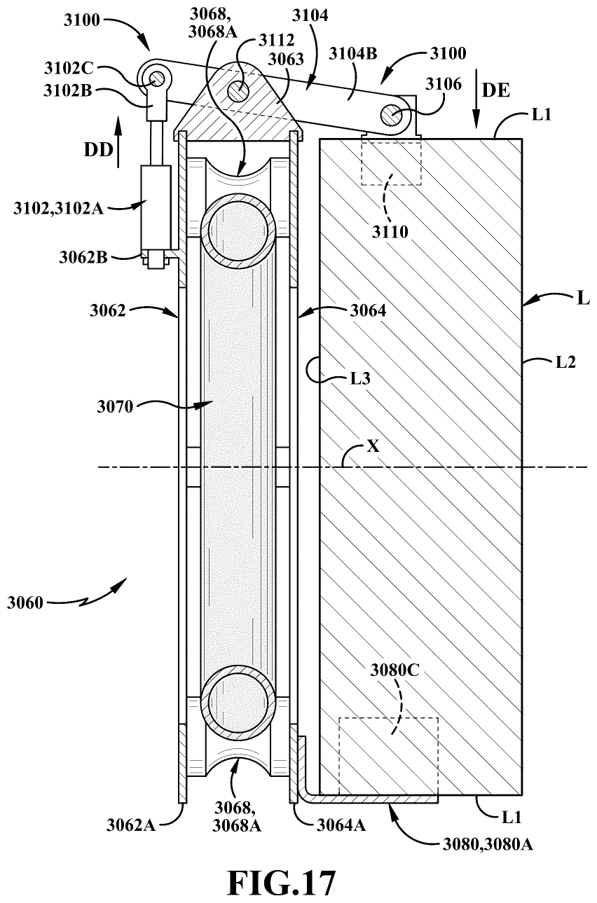

Once second ring 3064 of support assembly 3060 is placed in close proximity (or abutting contact) with side wall “L3” of load “L”, as illustrated in FIG. 17, air cylinder 3102 is actuated in the direction indicated by arrow “DD” to extend pivot rod 3102B further outwardly from body 3102A. This motion causes arm 3104 to pivot about second pivot pin 3112 and causes the first jaw 3108 and second jaw 3110 to move inwardly towards the circumferential surface “L1” of the load “L” in the direction indicate by arrow “DE”. Air cylinder 3102 continues to be actuated in the direction “DD” until clamping assembly 3100 tightly clamps load between first and second jaws 3108, 3110 and support plate 3080. This is illustrated in FIG. 17.

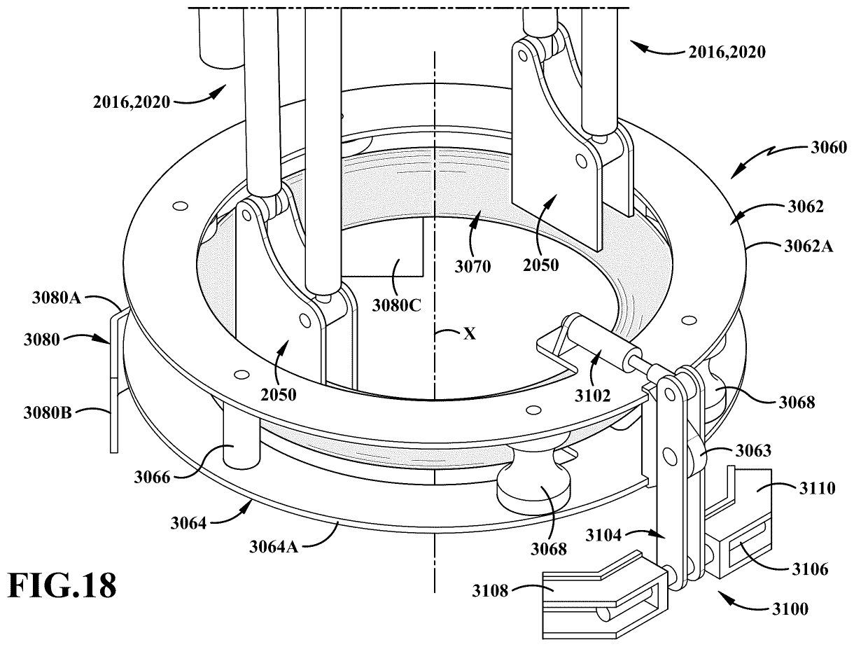

Referring now to FIG. 18, support assembly 3060 is shown installed on articulating assembly 2020. Specifically, connectors 2050 of the pair of second linkage assemblies 2016 are shown as being nonremovably secured to cylindrical pipe 3070 positioned between first ring 3062 and second ring 3064 of support assembly 3060. Cylindrical pipe 3070 is captured between first ring 3062 and second ring 3064 but is free to rotate between the first and second rings 3062, 3064 as the load balancer is actuated to articulate the support assembly 3060 and the load “L” engaged therewith and is manipulated and maneuvered by support mechanism “S”. Pipe 3070 is rotatable through 360 degrees about axis “X” (FIG. 12) in the directions indicated by arrows “DE”. Axis “X” extends through the center point of support assembly 3060. As the load balancer is moved, cylindrical pipe 3070 can rotate because it is seated in the arcuate groove 3068A of the rotators 3068. In other words, the rotators 3068 and cylindrical pipe 3070, together, comprise a bearing assembly provided between first ring 3062 and second ring 3064 of support assembly 3060. The tubular members 3066 aid in keeping the cylindrical pipe 3070 centered within support assembly 3060. Alternatively, the first and second rings 3062, 3064 can rotate relative to the cylindrical pipe 3070.

It should be noted that articulating assembly 3020 is configured to rotate the support assembly 3060 and thereby the load “L” attached thereto through 90 degrees between the first position and the second position. Support assembly 3060 is capable of being rotated through 360 degrees because the pipe 3070 and first and second rings 3062 and 3064 are capable of rotating relative to one another.

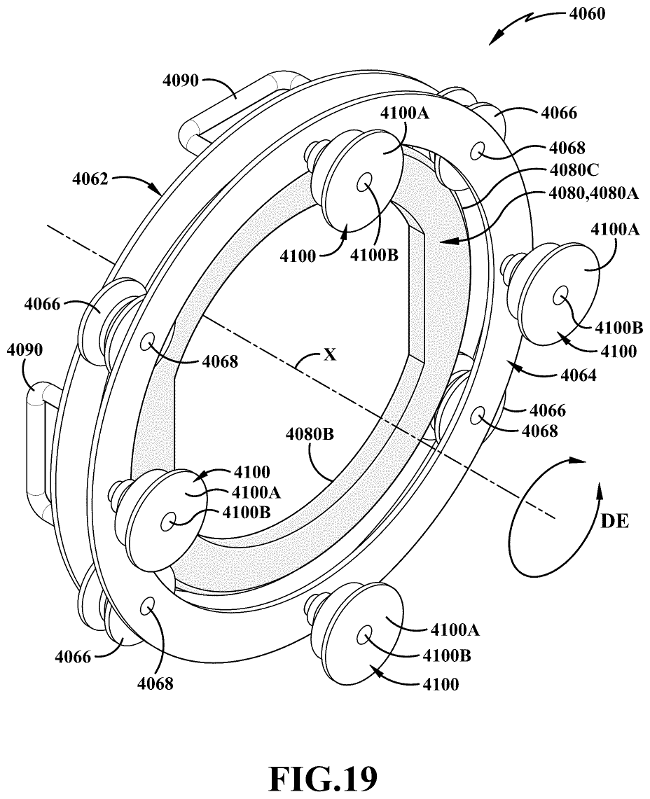

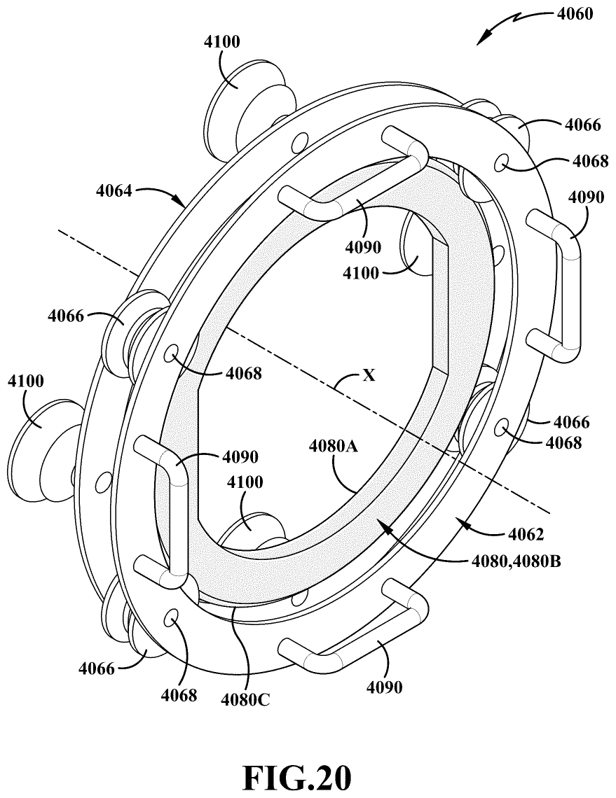

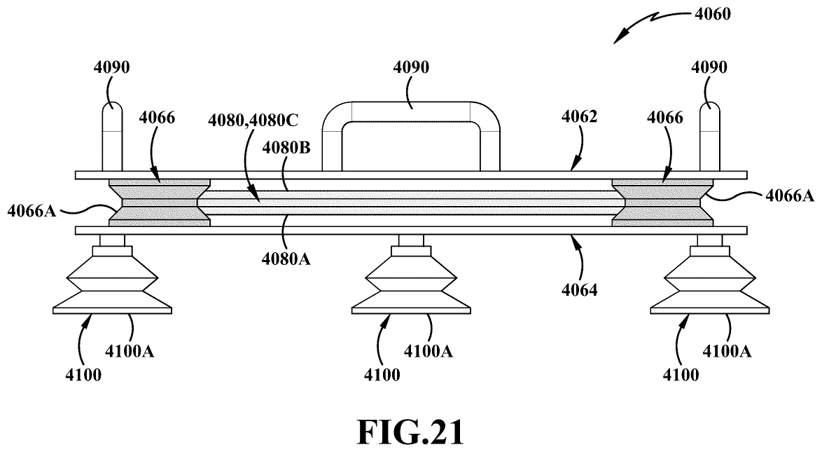

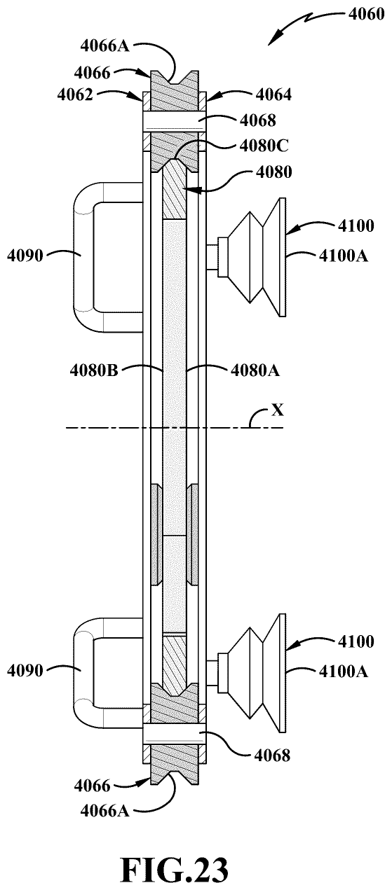

Referring now to FIGS. 18-23, there is shown a third embodiment of a support assembly suitable for engagement with any of the load balancers disclosed herein in accordance with an aspect of the present disclosure. The third embodiment support assembly is generally indicated at 4060 (FIG. 19). It will be understood that support assembly 4060 is operably engageable with any articulating assembly illustrated in the attached figures of the respective load balancers disclosed herein. Referring to FIG. 18, support assembly 4060 comprises a first ring 4062 and second ring 4064 located parallel and opposite one another and spaced laterally apart from one another. First ring 4062 and second ring 4064 are fixed to one another via a plurality of rollers 4066 and associated pins 4068. Plurality of rollers 4066 extend between an inner surface of first ring 4062 and an inner surface of second ring 4064. The plurality of rollers 4066 are spaced equidistant from one another around the circumferences of first ring 4062 and second ring 4064. As best seen in FIG. 23, each roller 4066 is mounted on pin 4068 which extends through aligned holes (not numbered) defined in the first and second rings 4062, 4064 and the roller 4066. Each roller 4066 is rotatable about the associated pin 4068.

As best seen in FIG. 23, each roller 4066 defines an annular groove 4066A therein. Annular groove 4066A has a truncated open V-shape. The purpose of the annular groove 4066A will be described later herein.

Referring to FIGS. 18-20, support assembly 4060 further comprises an inner ring 4080 which is captured between first ring 4062 and second ring 4064 and is seated in the annular groove 4066A of the plurality of rollers 4066 extending between first and second rings 4062, 4064. Inner ring 4080 is configured to operably engage the any of the articulating assembly illustrated in the attached figures of the associated load balancer disclosed herein. Inner ring 4080 includes a first side 4080A and a second side 4080B located parallel and opposite to one another and spaced laterally apart from one another. A circumferential edge 4080C of inner ring 4080 is configured to be complementary to the annular groove 4066A of rollers 4066. In particular, the circumferential edge 4080C has a truncated V-shape that is configured to be operably engaged with the rollers 4066. Like support assembly 3060, support assembly 4060 is configured to be operably engaged with the articulating assembly of one of the load balancers disclosed herein. For example, the connector of one or more of the second linkage assemblies, such as connector 2050 of second linkage assemblies 2016 may be welded or otherwise secured to second surface 4080B of inner ring 4080. As load balancer is manipulated to articulate a load attached to support assembly 4060, rollers 4066 may rotate first and second rings 4062, 4064 relatives to inner ring 4080, or inner ring 4080 will rotate relative to first and second rings 4062, 4064. Inner ring 4080, for example, is able to rotate through 360 degrees about axis “X” as indicated by arrows “EA”. Axis “X” extends through the center point of support assembly 4060.

Support assembly 4060 further comprises at least one handle 4090 extending outwardly from an outer surface of first ring 4062. Handles 4090 are oriented orthogonally to the outer surface of first ring 4062 and are preferably spaced equidistant from one another. Handles 4090 are provided to give an operator some way to hold onto support assembly 4060 to aid in manipulating the same should such manipulation be necessary or helpful.

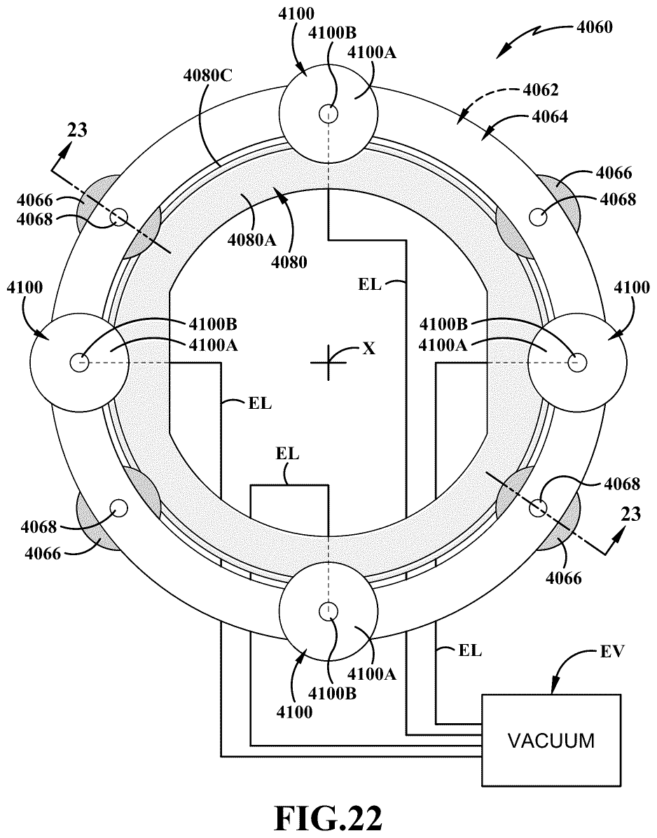

Still referring to FIGS. 19 to 23, support assembly 4060 further comprises a plurality of securement members 4100 extending outwardly from an outer surface of second ring 4064. The plurality of securement members 4100 are arranged equidistant from one another around the circumference of second ring 4064. Each one of the plurality of securement members 4100 includes an end surface 4100A adapted to be placed in direct contact with an exterior surface of the load “L” to be engaged by support assembly 4060. Each of the plurality of securement members 4100 further defines a passageway which extends therethrough and terminates in an opening 4100B defined in end surface 4100A. Although shown diagrammatically in FIG. 22, it will be understood that each securement member 4100 will be connected by appropriate airlines “EL” to a remote vacuum source “EV”. The remote vacuum source “EV” may be actuated to suction air through opening 4100B, through the associated passageway and airlines “EL” to create a vacuum condition when end surface 4100A is placed in contact with an exterior surface of a load.

Referring now to FIG. 22, each one of the plurality of securement members 4100 comprise vacuum cups attached to the remote vacuum source “EV” via airlines “EL”.

Although not illustrated herein, it will be understood that in order to secure a load to support assembly 4060, such as is illustrated in FIG. 3A with respect to support assembly 60, when support assembly 4060 is moved into the first position (orthogonal to the ground surface “GS” and vertical axis “Y”, the plurality of securement members 4100 will hang downwardly from second ring 4064. When the load balancer to which support assembly 4060 is engaged lowers the load balancer to contact the second side wall of the load “L”, the end surfaces 4100A of the securement members 4100 will contact the second side wall of the load “L”. The vacuum source will be activated and a vacuum condition will be set up between each securement member 4100 and the second side wall of the load “L”. Once securement members 4100 are securely engaged with the load “L”, the load balancer may be articulated to the second position (like that shown in FIG. 3B). The vacuum condition is always maintained during the articulation operation to ensure load “L” does not break contact with support assembly 4060.

If the load “L” is a tire that is to be installed on a vehicle, for example, once the tire has been installed on the axel, the vacuum source “EV” is deactivated, and this breaks the vacuum condition at end surface 4100A of the various securement members 4100. As a result, the securement members 4100 will break contact with the second side wall of the load “L”. The load balancer may then be actuated to articulate support assembly 4060 back to the first position while the support mechanism manipulates load balancer away from the vehicle.

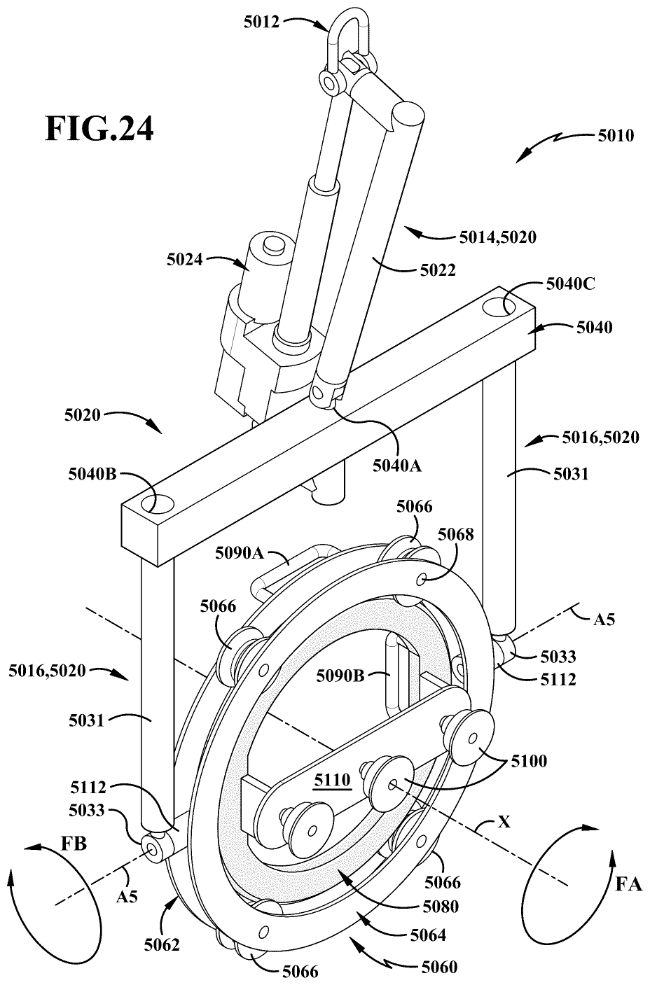

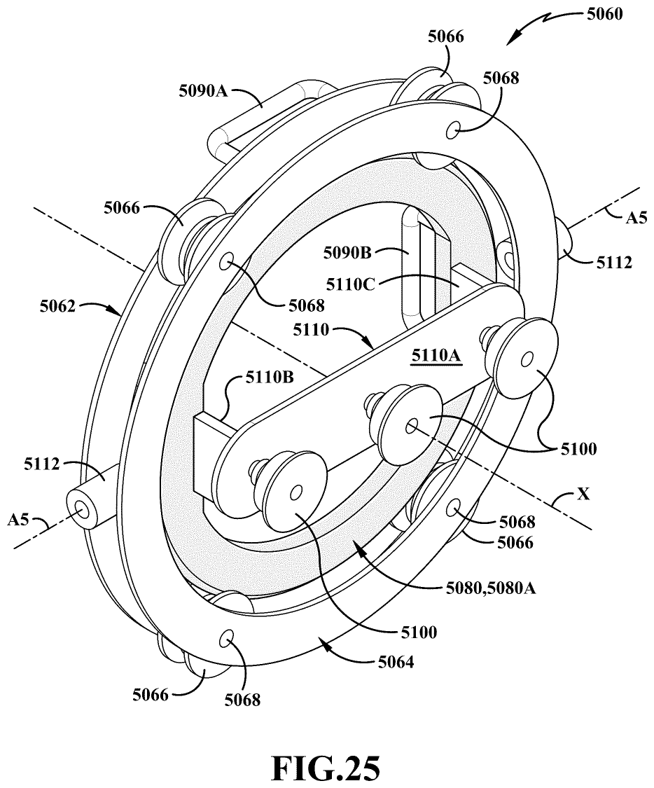

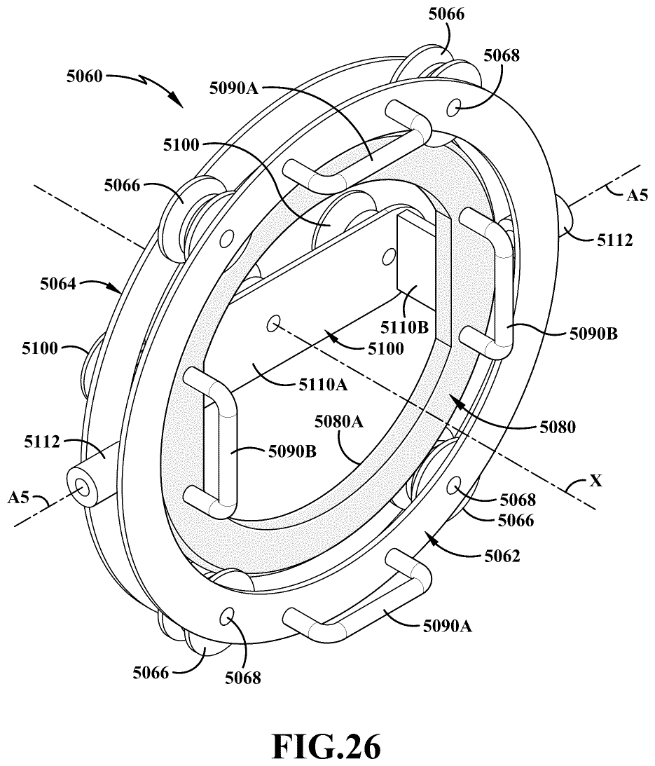

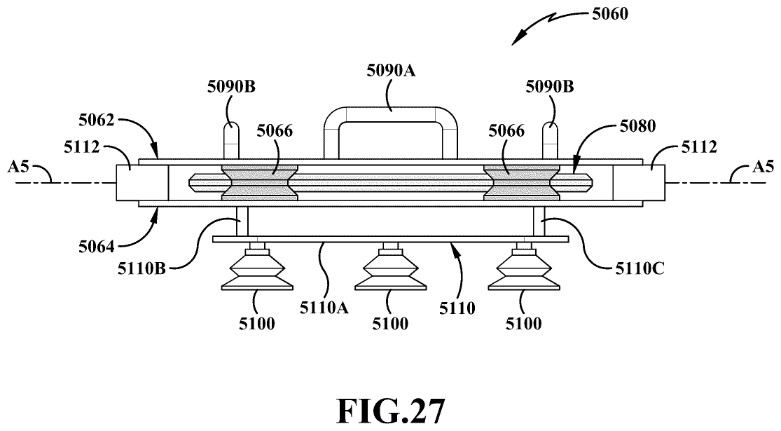

Referring now to FIGS. 24-27, there is shown a fourth embodiment of a load balancer in accordance with the present disclosure, generally indicated at 5010. Load balancer 5010 comprises an attachment member 5012, an articulating assembly 5020, and a support assembly 5060. Articulating assembly 5020 comprises a first linkage assembly 5014 and a second linkage assembly 5016. Attachment member 5012 is substantially identical to attachment member 12 and therefore will not be described in much detail hereafter. First linkage assembly 5014 is substantially identical to first linkage assembly 2014 and therefore will not be described in much detail hereafter.

Second linkage assembly 5016 differs from second linkage assemblies 16, 1016 and 2016. Second linkage assembly comprises a connector bridge 5040 and a pair of second arms 5031. Connector bridge 5040 is identical in structure and function to connector bridge 2040 and defines three apertures 5040A, 5040B, and 5040C therein. First linkage assembly 5014 engages connector bridge 5040 via first aperture 5040A in a substantially identical manner to how first linkage assembly 2014 engages connector bridge 2040 via first aperture 2040A and will therefore not be discussed in any further detail herein.

A first end of each of the second arms 5031 of second linkage assembly 5016 is received into a respective one of the second aperture 5040B and third aperture 5040C of connector bridge 5040. Although not fully illustrated in FIG. 24, it will be understood that a rod end bolt 5033 is provided at the second end of each second arm 5031. The rod end bolts 5033 are provided for engagement with support assembly 5060 as will be described later herein.

Referring to FIG. 24-27, the fourth embodiment of support assembly 5060 in accordance with an aspect of the present disclosure is substantially similar to support assembly 4060 in many aspects but differs in other aspects Support assembly 5060 comprises a first ring 5062 and second ring 5064 located parallel and opposite one another and spaced laterally apart from one another. First ring 5062 and second ring 5064 are fixed to one another via a plurality of rollers 5066 and associated pins 5068. The plurality of rollers 5066 extend between an inner surface of first ring 5062 and an inner surface of second ring 5064. The plurality of rollers 5066 is spaced equidistant from one another around the circumferences of first ring 5062 and second ring 5064. Each roller 5066 is mounted on pin 5068 which extends through aligned holes (not numbered) defined in the first and second rings 5062, 5064 and the roller 5066. Each roller 5066 is rotatable about the associated pin 5068. As with support assembly 4060, each roller 5066 of support assembly 5060 defines an annular groove having a truncated open V-shape. An inner ring 5080 is captured between first ring 5062 and second ring 5064 and is seated in the annular groove defined by each of the plurality of rollers 5066. Unlike inner ring 4080, inner ring 5080 is not configured to be operably engaged with the articulating assembly 5020 of the associated load balancer 5010. It will later be described how support assembly 5060 is engaged with articulating assembly 5020.

Support assembly 5060 further comprises a first set of handles 5090 extending outwardly from an outer surface of first ring 5062.

Support assembly 5060 further comprises a plurality of securement members 5100 arranged on a plate 5110 attached to first side 5080a of inner ring 5080. Plate 5110 attaches to a first side 5080A of fixed ring 5080. As illustrated, plate 5110 is generally U-shaped and comprises a middle region 5110A and two arms 5110B, 5110C. First arm 5110B and a second arm 5110C are oriented orthogonally to first side 5080A of inner ring 5080. Consequently, middle region 5110A and securement members 5100 are located a distance outwardly away from first side 5080A of inner ring 5080. The plurality of securement members 5100 are arranged equidistant from one another along a length of plate 5110. Securement member 5100 are substantially identical to securement members 4100 in structure and function and therefore will not be described in any further detail herein. Any desired number of securement members 5100 may be provided on plate 5110. Each one of the plurality of securement members 5100 includes an end surface 5100A which defines an opening 5100B to a passageway that is adapted to be connected to a remote vacuum source. The end surface 5100A of each securement member 5100 is placed in abutting contact with a portion of the exterior surface of a load (not shown) when it is desired to secure the load to support assembly 5060 and thereby to load balancer 5010.

Referring still to FIGS. 24-27, support assembly 5060 further comprises a set of rotation posts 5112 secured between the inner surface of first ring 5062 and the inner surface of second ring 5064. Posts 5112 are configured to be operatively engaged with second linkage assembly 5016 of load balancer 5010 via the rod end bolts 5033 provided at the second ends of second arms 5031. Inner ring 5080 of support assembly 5060 is able to rotate through 360 degrees relative to first ring 5062 and second ring 5064 and about an axis “X” and in the direction indicated by arrows “FA” (FIG. 24). Axis “X” extends through center point of support assembly 5060. Support assembly 5060 itself is rotatable through 360 degrees about an axis “A5” extending along the rotation posts 5112 as indicated by arrows “FB” (FIG. 24). Axis “A5” is orthogonal to axis “X”, i.e., at 90 degrees relative to axis “X”. Support assembly 5060 is secured to second linkage assembly 5016 along axis “A5”.

Having now described support assembly 5060, a method of using support assembly 5060 to secure and manipulate a load will be described.

While not depicted in the figures, it will be understood that attachment member 5012 can be secured to a support mechanism in a similar fashion to how attachment member 12 is secured to support mechanism “S” in FIG. 1. The support mechanism is actuated to lower load balancer 5010 towards the load. When securement members 5100 contact an exterior surface of the load, a remote vacuum source is activated, and the load is thereby secured to support assembly 5060 via vacuum suction.

Once the load is secured to support assembly 5060, a user can grasp handles 5090 to rotate support assembly 5060 and its secured load about axis “A5” in one of the directions of arrow “FB” (FIG. 24) to orient the load in a desired position. It should be noted that support assembly 5060 is able to be rotated through 360 degrees about the axis “A5”. While the rotation is described herein as being actuated by a user grasping handles 5090 and manipulating support assembly 5060, in other embodiments, this rotation may be motorized.

The user may further utilize the handles 5090 to rotate the inner ring 5080 and thereby the secured load relative to the first ring 5062 and the second ring 5064 via the plurality of rollers 5066 in one of the directions indicated by arrows “FB” (FIG. 24) about axis “X” to further orient the load. It should be noted that the rotation of inner ring 5080 relative to first and second rings 5062, 5064 is able to be rotation through 360 degrees. Axis “X” extends through center point of support assembly 6060. While this rotation about axis “X” is further described herein as being the result of the user applying a force to support assembly 5060 via handles 5090, in other embodiments, the rotation may be motorized. First linkage assembly 5014 may further be actuated to move the connector bridge 5040, the second linkage assembly 5016, the support assembly 5060 and the associated load from a first position to a second position (through 90 degrees) or to any position between the first position and the second position so that the load can be placed where it is required.

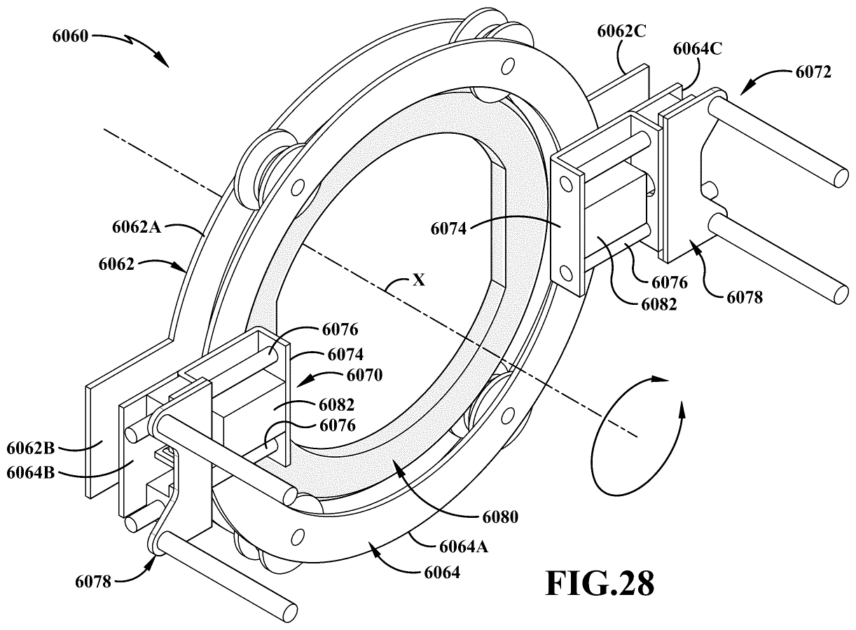

Referring now to FIGS. 28-32, there is shown a fifth embodiment of a support assembly 6060 in accordance with an aspect of the present disclosure. Support assembly 6060 is substantially similar to support assembly 4060 in many aspects but differs in other aspects. It will be understood support assembly 6060 is suitable for engagement with any of the load balancers disclosed herein in the place of other embodiment of the support assemblies illustrated in the attached figures.

Support assembly 6060 is similar to support assembly 4060 in that it comprises a first ring 6062 and a second ring 6064 located parallel and opposite one another and spaced laterally apart from one another. Support assembly 6060 further comprises a Third ring 6080 placed between first ring 6062 and second ring 6064. Third ring 6080 is substantially identical in function and structure to inner ring 4080 shown in FIG. 19 and therefore will not be described in more detail. Support assembly 6060 comprises a plurality of rollers 6068 interposed between an inner surface of the first ring 6062 and an inner surface of the second ring 6064.

Support assembly 6060 is different to support assembly 4060 in that first ring 6062 has a peripheral edge 6062A and a pair of opposed flanges 6062B, 6062C extending radially outwardly from the peripheral edge 6062A. Second ring 6064 has a peripheral edge 6064A and a pair of opposed flanges 6064B, 6064C extending radially outwardly from the peripheral edge 6064A.

Support assembly 6060 is further different from support assembly 4060 in that second ring 6064 comprises a first mount 6070 and a second mount 6072. First mount 6070 and second mount 6072 welded or otherwise secured on the outer surface of the second ring 6064 and the associated flanges 6062B, 6062C. First mount 6070 and second mount 6072 are arranged on second ring 6064 as mirror images of one another and are oriented opposite to one another. Other than their orientation, first mount 6070 and second mount 6072 are identical to one another. It will be understood that the following description of first mount 6070 will apply equally to second mount 6072.

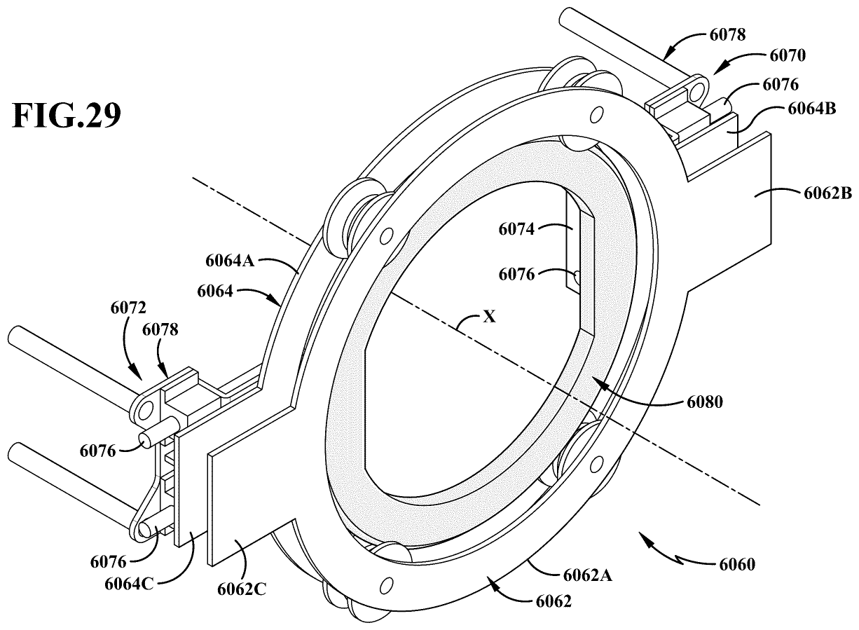

As best seen in FIGS. 28 and 29, first mount 6070 comprises a housing 6074 engaged with the outer surface of second ring 6064 and flange 6064B. First mount 6070 further comprises a pair of shafts 6076 extending through the housing. First mount 6070 further comprises an securement mechanism 6078 operatively engaged with the housing 6074 and configured to move along the pair of shafts 6076 via controller 6082.

While securement mechanism 6078 is illustrated herein as having a plate and a pair of rods extending outwardly from the plate, this shape is exemplary only and, in other embodiments, securement mechanism 6078 may be differently configured from what is illustrated in the attached figures. No matter the shape of securement mechanism 6078, first mount 6070 and second mount 6072 are configured to be able to engage and secure a load “L”. In one embodiment, the pair of rods may be received within a portion of the load “L”.

Having now described support assembly 6060, a method of using support assembly 6060 to secure a load “L” will be described.

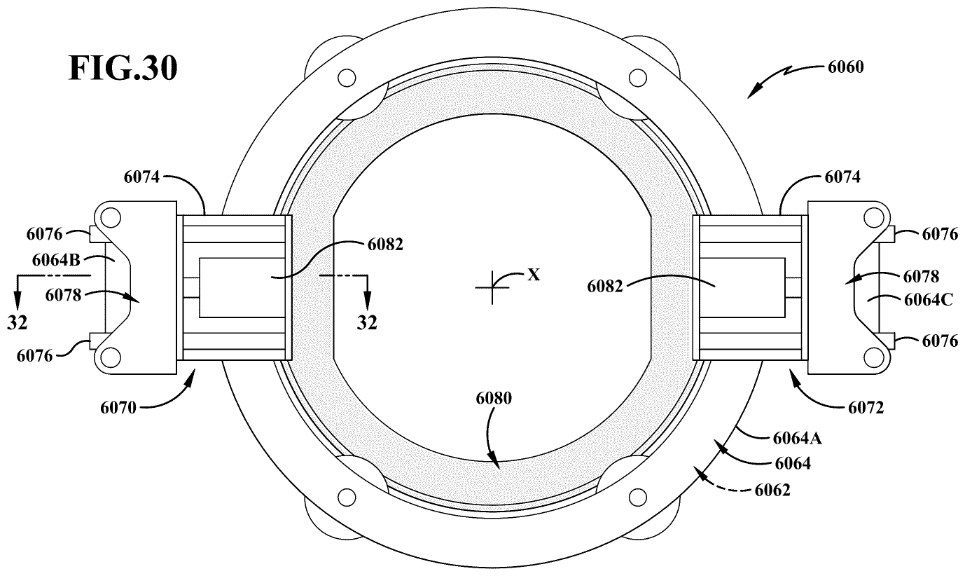

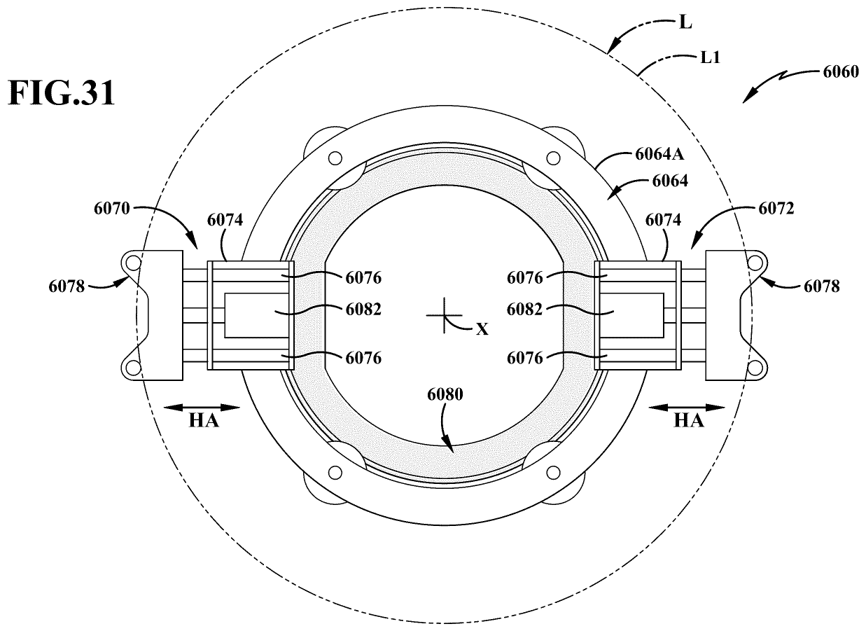

Referring now FIGS. 30 and 31, when an operator wishes to engage and secure the load “L” to support assembly 6060, the operator will first set the position of the support assembly 6060 relative to the load “L”.

Referring now to FIG. 31, support assembly 6060 is adjusted to be larger than the portion of the load “L” to be engaged therewith, in particular the position of the first mount 6070 is varied relative to the position of the second mount 6072 to increase the distance therebetween. This distance is adjusted by engaging the controller 6082 to move the securement mechanism 6078 along the pair of shafts 6076 of first and second mount 6070, 6072. The adjustment of the securement mechanism 6078 relative to the housing 6074 is indicated in FIG. 31 by the arrows “HA”. Initially, the distance between attachment mechanisms 6078 of first mount 6070 and second mount 6072 must be slightly larger than the dimensions of the portion of the load “L” to be engaged with support assembly 6060.

Once second ring 6064 of support assembly 6060 is placed in close proximity (or abutting contact) with a side wall “L3” of the load “L” attachment mechanisms 6078 of first mount 6070 and second mount 6072 are moved inwardly toward the circumferential surface “L1” of the load “L” via controller 6082. The movement is continued until securement mechanism 6078 firmly secures the load “L” to support assembly 6060. The load “L” is secured to support assembly 6060 by friction and compression.

In another embodiment, the first and second mount 6070, 6072 may be moved inserted into a recess or aperture of a load and be moved outwardly relative to one another to secure the load to support assembly 6060.

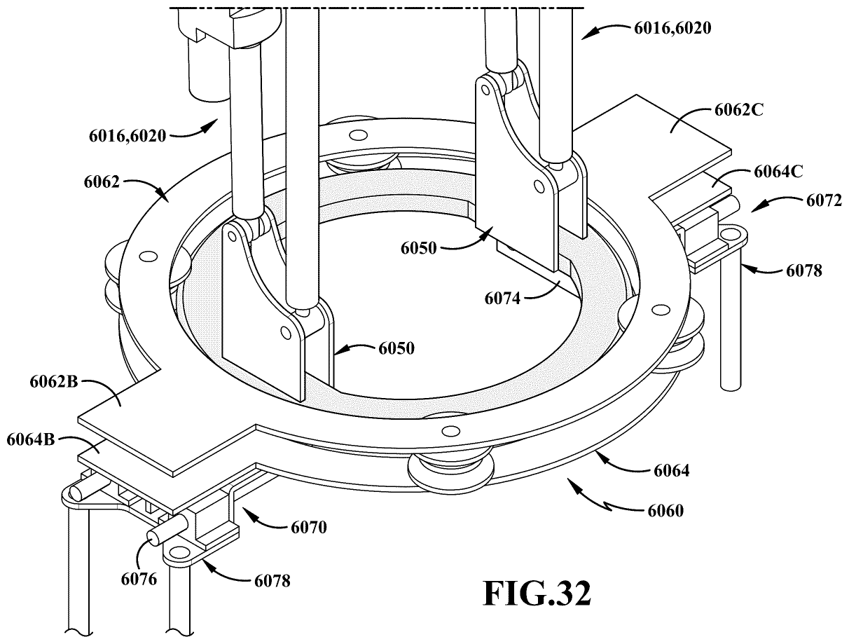

Referring now to FIG. 32, support assembly 6060 is shown installed on articulating assembly 6020. Articulating assembly 6020 is substantially identical to articulating assembly 2020. Specifically, connectors 6050, of the pair of second linkage assemblies 6016 are shown as being nonremovably secured to an outer surface of third ring 6080. Each of the pair of second linkage assembly 6016 comprise a second arm 6028 substantially identical to second arm 2028 of articulating assembly 2020, shown in FIG. 10. Articulating assembly 6020 can be actuated to move support assembly 6060 and thereby the load “L” from the first position to a second position in a similar fashion to the load balancer 10 as shown in FIGS. 3A-3C. Articulating assembly 6020 can further be actuated to rotate support assembly 6060 and thereby the load “L” through 360 degrees about axis “X” (FIG. 28). Axis “X” extends through center point of support assembly 6060.

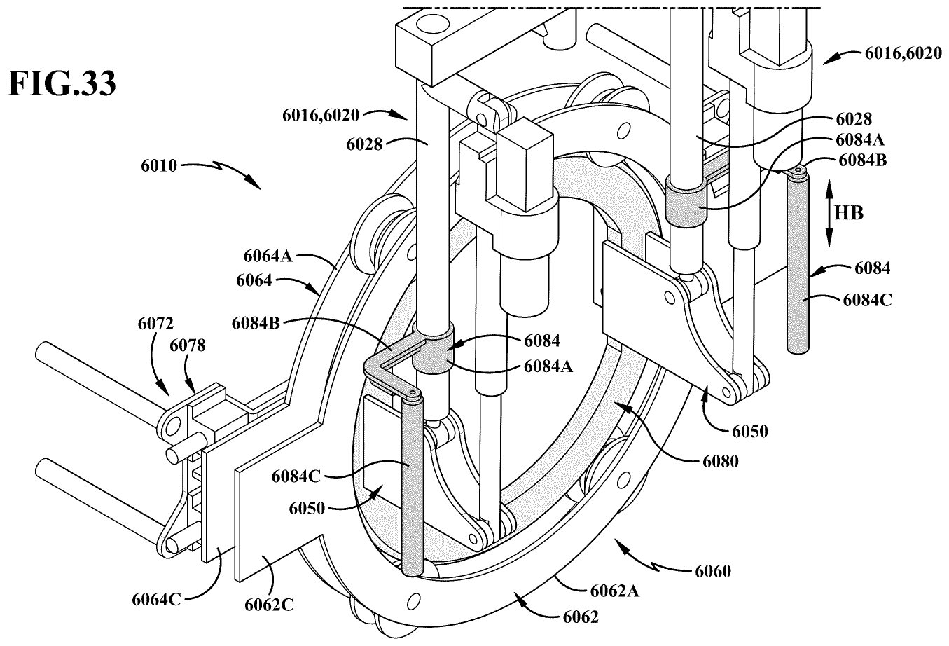

Referring now to FIG. 33, each one of the pair of second linkage assemblies 6016 comprises a handle assembly 6084. Handle assembly 6084 comprising a mounting member 6084A which engages the second arm 6028. Handle assembly 6084 further comprising a linking bar 6084B extending outwardly from the mounting member 6084A and a grip 6084C extending outwardly from the linking bar 6084B. Mounting assembly 6084A and thereby handle assembly 6084 is slidable along second arm 6028 as indicated by arrows “HB” in FIG. 33. Handle assembly 6084 may be using by a user to manipulate load balancer 6010.

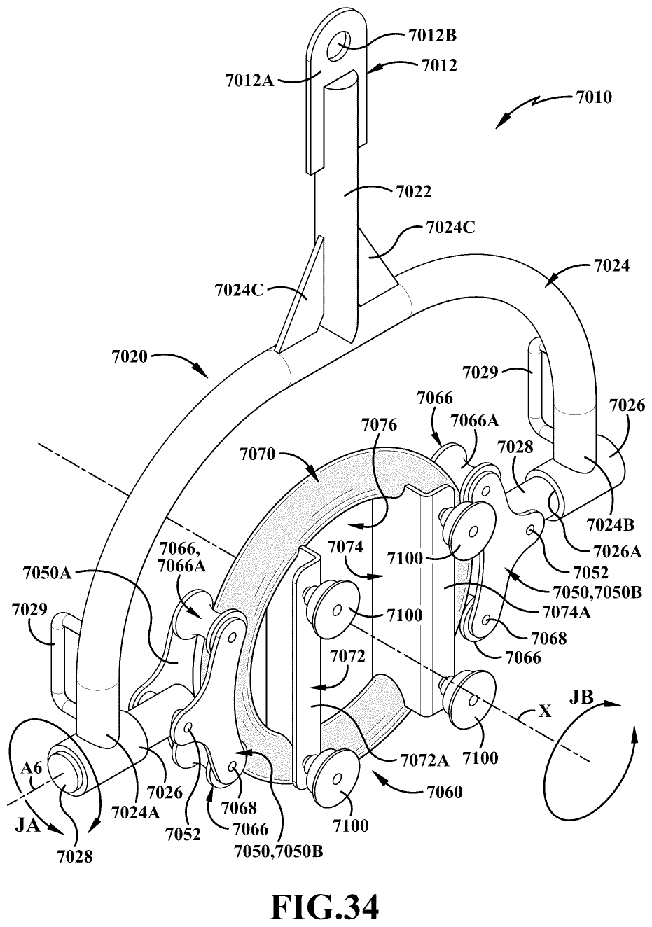

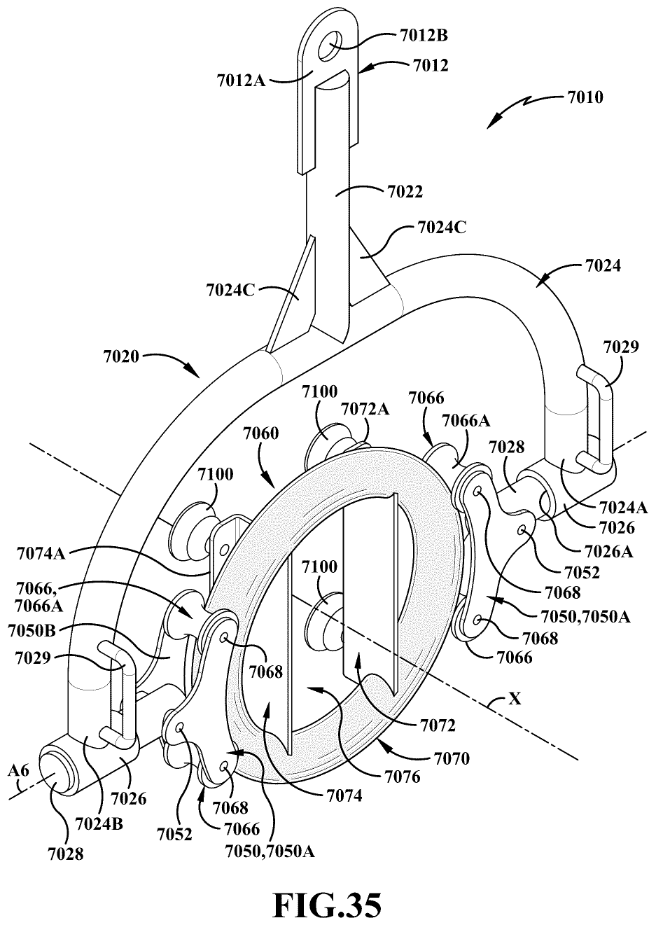

Referring to FIGS. 34 and 35, there is also shown a fifth embodiment of a load balancer in accordance with an aspect of the present disclosure, generally indicated at 7010. Load balancer 7010 generally includes an attachment member 7012, an articulating assembly 7020 and a support assembly 7060.

Referring to FIG. 34, attachment member 7012 comprises an attachment plate 7012A which defines a hole 7012B therein. Attachment plate 4012A is configured to operably receive a hook from a support mechanism through the hole 7012B in a similar manner to how attachment link 12A (FIG. 1) engages the hook “H” of support mechanism “S”.

Articulating assembly 7020 of load balancer 7010 is configured to operably secure the attachment member 7012 and the support assembly 7060 to one another. Articulating assembly 7020 enables the support assembly 7060 to move relative to the attachment member 7012. Support assembly 7060 is configured to engage a load thereto. Articulating assembly 7020 comprises a first arm 7022 operably engaged with attachment plate 7012A. In particular, first arm 7022 is fixedly engaged with attachment plate 7012A such as by being welded thereto. Articulating assembly 7020 further comprises a second arm 7024 operably engaged with first arm 7022. Second arm 7024 is curved to a degree where support assembly 7060 is located between a first end 7024A of second arm 7024 and a second end 7024B of second arm 7024. Bracing gussets 7024C extend between first arm 7022 and second arm 7024. A handle 7029 is provided on second arm 7024 adjacent each of the first and second ends 7024A, 7024B thereof.

In one specific embodiment, second arm 7024 is generally U-shaped.

Articulating assembly 7020 further comprises a receiver 7026 integral with each of the first end 7024A and the second end 7024B of second arm 7024. Each receiver 7026 is configured to define a bore 7026A therethrough. A connector assembly is engaged with each receiver. Each connector assembly comprises a tubular member 7028 and a connector 7050.

The tubular member 7028 of the connector assembly is received through the bore 7026A of the associated receiver 7026 and is rotatably engaged therewith. In particular, each tubular member 7028 is configured to be rotated about an axis “A6” as indicated by arrows “JA” (FIG. 34). Axis “A6” is orthogonal to axis “X”, i.e., at 90 degrees relative to axis “X”.

The connector 7050 of the connector assembly is engaged with tubular member 7028. Connector 7050 comprises a first plate 7050A and a second plate 7050B which are spaced apart and arranged parallel to one another. In the illustrated embodiment, connector 7050 is generally T-shaped. A first pivot rod 7052 pivotally engages connector 7050 to tubular member 7028. A pair of rollers 7066 extends between first plate 7050A and second plate 7050B and each roller 7066 is secured to the plates of connector 7050 by a pin 7068. Each roller 7066 has a circumferential wall which defines a concave groove 7066A, the purpose of which will be described later herein.

Referring now to FIG. 34, support assembly 7060 is rotatably engaged with articulating assembly 7020. Support assembly 7060 comprises a cylindrical pipe 7070 which is of an exterior diameter suitable to be received between the connector 7050 engaged proximate first end 7024A of second arm 7024 and the connector 7050 engaged proximate second end 7024B of second arm 7024. The radius of curvature of the circumferential surface of the pipe 7070 is complementary to the radius of curvature of the groove 7066A defined in the rollers 7066. Pipe 7070 is configured to be rotatably received in the grooves 7066A of the plurality of rollers 7066.

Support assembly 7060 further comprises a first mounting plate 7072 and a second mounting plate 7074 extending across at least a portion of the interior of cylinder pipe 6062. First mounting plate 7072 and second mounting plate 7074 are substantially identical in configuration but are arranged as mirror images of one another. Mounting plates 7072, 7074 are engaged with pipe 7070 in such a way that a base region of each plate extends across the gap 7076 defined by the inner circumferential surface of pipe 7070. Each mounting plate 7072, 7074 is generally L-shaped and presents a flange 7072A, 7074 which is oriented parallel to the plates of connector 7050 and is located a distance outwardly beyond the exterior surface of pipe 7070.

Support assembly 7060 further comprises at least one securement member 7100 extending outwardly from flanges 7072A, 7074A of mounting plates 7072, 7074. Each of the securement members 7100 is substantially identical in structure and function to securement members 4100 (FIG. 19) and is used in the same manner and for the same purpose as securement members 4100, i.e., to secure a load to support assembly 7060 when a remote vacuum source is activated.

Having now described load balancer 7010, a method of using load balancer 7010 to manipulate a load will now be described.

Load balancer 7010, like all other load balancers described herein, is engaged with a support mechanism (such as the support mechanism “S” shown in FIG. 1) by inserting a hook attached to a cable of the support mechanism through the hole 7012B of attachment member 7012. The support mechanism may be actuated to raise and lower and other wise move load balancer 7010 from one location to another in a factory, for example. When load balancer 7010 is located immediately above a load (such as load “L2” shown in FIG. 2), the support mechanism is actuated to lower the load balancer 7010 relative to a ground surface. When load balancer is more or less in the correct position, an operator may grasp the handles 7029 of articulating assembly 7020 and rotate the support assembly 7060 into the first position, i.e., substantially parallel to the ground surface and to an upper exterior surface of the load. The rotation of support assembly 7060 is around the axis “A6” in the direction indicated by arrows “JA”. It should be noted that support assembly 7060 is capable of being rotated through 360 degrees about axis “A6”. In particular, the operator rotates the support assembly 7060 in such a manner as to ensure the securement members 7100 face the ground surface upon which the load rests. The support mechanism is then used to continue to lower the load balancer 7010 and thereby the support assembly 7060 towards the load until the end surfaces 7100A (FIG. 31) of the various securement members 7100 contacts the exterior surface of the load. The operator may rotate the pipe 7070 around axis “X” and in the direction indicated by arrows “JB” to ensure that all or most of the securement members 7100 abut the exterior surface of the load. It should be noted that pipe 7070 and first and second rings 7062, 7064 are capable of being rotated through 360 degrees relative to one another and about axis “X”. Axis “X” extends through center point of support assembly 7060. A remote vacuum source is activated and a vacuum condition is created between the end surfaces 7100A of the securement member 7100 and the exterior surface of the load. The vacuum condition secures the load to the support assembly 7060.

The operator is then able to grasp the handles 7029 on articulation assembly 7020 to move the support assembly 7060 and thereby the load engaged therewith into the correct orientation as needed. This can be done by rotating the support assembly 7060 about axis “A6” or the cylindrical pipe 7070 about axis “X” as needed. When the operator has corrected positioned the load using the load balancer 7010, the remote vacuum source can be switched off to break vacuum suction between the securement member 7100 and the load.

It will be understood that in other embodiments handles may additionally be provided on cylindrical pipe 7070 or on the mounting plates 7072, 7074 to aid the operator in manipulating support assembly 7060 or pipe 7070.

In one embodiment, the load balancer may be inverted relative to the manner in which the load balancer is illustrated in the attached figures. In these embodiments, the support mechanism may comprise a mounting block or similar object to which the load balancer may be mounted. Further in these embodiments, the load balancer is not suspended from the support mechanism, but rather extends upwardly therefrom.

The device, assembly, or system of the present disclosure may additionally include one or more sensors to sense or gather data pertaining to the surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the second arm 4024 being U-shaped, the second arm 4024 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “α” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A load movement effector comprising:
an articulating assembly operatively engaged with a support mechanism;
a support assembly adapted to engage and secure a load thereto; and
wherein the articulating assembly moves the support assembly and thereby changes the position of the load.

2. The load movement effector according to claim 1, wherein the articulating assembly rotates the support assembly and thereby the load about at least one axis.

3. The load movement effector according to claim 2, wherein the at least one axis comprises a first axis which extends through a center point of the support assembly.

4. The load movement according to claim 3, wherein the at least one axis further comprises a second axis which orthogonal to the first axis.

5. The load movement effector according to claim 1, further comprising:
an attachment mechanism operatively engaged with the articulating assembly, wherein the attachment mechanism engages the articulating assembly to the support mechanism.

6. The load movement effector according to claim 5, wherein the articulating assembly comprises:
a first arm fixedly engaged with the attachment mechanism;
a second arm engaged with the first arm;
a receiver provided at each of a first end and a second end of the second arm;
a connector assembly operatively engaged with each receiver; and
wherein each connector assembly engages the support assembly.

7. The load movement effector according to claim 6, wherein the connector assembly comprises:
a first plate and a second plate opposed and spaced apart from one another;
one or more rollers rotatably extending between the first plate and the second plate; and
a rod pivotally engaged with first plate and the second plate; and
wherein the rod engages an associated receiver of the articulating assembly.

8. The load movement effector according to claim 1, wherein the support assembly comprises:
a ring which rotatably engages the articulating assembly.

9. The load movement effector according to claim 8, wherein the support assembly further comprises:
at least one securement member adapted to engage the load.

10. The load movement effector according to claim 9, wherein the at least one securement member is provided on the ring.

11. The load movement effector according claim 1, further comprising:
at least one handle provided on the articulating assembly.

12. A method of effecting a load comprising:
providing a support mechanism;
engaging an attachment mechanism with the support mechanism;
nonremovably engaging an articulating assembly with the attachment mechanism;
engaging a support assembly with the articulating assembly; and
securing the load to the support assembly.

13. The method according to claim 12, further comprising:
providing a pair of connector assemblies on the articulating assembly;
rotating the support assembly about a first axis with the pair of connector assemblies; and
wherein the first axis extends through a center point of the support assembly.

14. The method according to claim 13, further comprising:
rotating the support assembly with the articulating assembly about a second axis orthogonal to the first axis.

15. The method according to claim 12, further comprising:
moving the attachment mechanism, the articulating assembly, the support assembly, and thereby the load via at least one handle located on the articulating assembly.

16. The method according to claim 12, further comprising:
providing at least one securement member on the support assembly; and
securing the load to the support assembly via at the at least one securement member.

17. The method according to claim 12, further comprising:
providing at least one vacuum cup on the support assembly;
connecting the at least one vacuum cup to a remote vacuum source;
creating a vacuum between the at least one vacuum cup and the load; and
securing the load to the support assembly via the vacuum.

18. The method according to claim 12, further comprising:
providing at least one magnet assembly on the support assembly;
generating a magnetic field with the at least one magnet assembly; and
attracting the load to the support assembly via the magnetic field.

19. The method according to claim 12, further comprising:
providing at least one clamp assembly on the support assembly; and
clamping the load to the support assembly with the at least one clamp assembly.

20. The method according to claim 12, further comprising:
providing a support plate extending outwardly from the support assembly;
providing at least one clamping jaw opposed to the support plate;
receiving the load between the support plate and the at least one clamping jaw; and
clamping the load between the support plate and the at least one clamping jaw.
